(19) United States
(12) Patent Application Publication
(10) Pub. No.: US 2003/0167447 A1
(43) Pub. Date: Sep. 4, 2003

(54) Layout editing program

(75) Inventors: Atsushi Hatta, Nagano-ken (JP); Nobuhisa Takabayashi, Nagano-ken (JP); Masaru Hoshino, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/308,186

(22) Filed: Dec. 3, 2002

(30) Foreign Application Priority Data
Dec. 4, 2001 (JP) 2001-370374

(51) Int. Cl. G06F 15/00

(52) U.S. Cl. 715/517

(57) ABSTRACT

Operations wherein print layout(s) is or are edited and print job(s) is or are created are made capable of being carried out efficiently. In template mode, apportionment of image(s) is ordinarily carried out with template(s) being set for each individual page. Group(s) are closed for each page. Package(s) may be such that a plurality of templates are treated as a single pack (multiple pages), and group(s) within package(s) may be such that all are treated as if it or they are the same group(s), the same image(s) being assignable thereto. List(s) (dropdown list(s)) of name(s) of template(s) corresponding to print media size(s) specified at media/printer selection area 146 may be displayed at screen(s) which is or are presented when package(s) is or are employed. Layout editor(s) obtain such template information (dropdown list(s)) from print server machine(s). Upon selection of only a single desired template name from such a list, description(s) of that template name may be displayed below that list and selected template(s) may be displayed at layout display area(s).

### FIELD OF ART

The present invention relates generally to a printing system employing computer(s) and electronic printer(s), and pertains more particularly to a printing system suited to operations, from the taking of photograph(s) to the printing thereof, taking place at photo studio(s).

### BACKGROUND ART

As a result of improvements in digital camera and electronic printer performance, not only amateurs but also photographic industry professionals have begun using digital cameras and electronic printers. Amateurs as well as professionals typically make use of a simple system wherein an electronic printer is connected by way of a dedicated interface cable, LAN, or the like to a personal computer on which a photo retouching program is installed. Use of a sophisticated photo retouching program makes it possible to carry out a diverse variety of retouching and/or color correction operations on photographic images taken with a digital camera, and/or freely vary the size and/or resolution of such images. Inkjet printers are favorably used as such electronic printers, as they permit printed output of high-quality full-color photographs that are as good as silver halide photographs.

The typical system described above performs extremely well in terms of its ability to permit each individual photograph to be finished as necessary to achieve a quality print which can then be output. However, at photo studios or other such sites dealing with commercial or professional photographic prints, a variety of other capabilities are required in addition to capabilities related to high-quality print generation.

First and foremost, professionals demand the ability to produce printed output having color that is consistent with what they were expecting. One factor which interferes with this ability is the fact that the characteristics affecting color in digital cameras, computer display monitors, printers, and other such image processing devices differ from device to device. For this reason, the color of the original image taken with the camera, the color of the image on the monitor screen, and the color of the image which is printed out will all be different. Despite this, conventional systems do not possess the capability to automatically adjust color to compensate for differences in color characteristics among devices. Unless the user has a good understanding of the color characteristics of each device and manually adjusts color himself or herself in, for example, photo retouching software or the like, the user will be unable to produce printed output having color that is consistent with what the user was expecting.

Second, the ability to efficiently process studio business is demanded. For example, as the operation which takes the most time at a photo studio is the retouching of photographs, there is a demand for reduction in the amount of time that must be set aside for same. Conventional photo retouching software is provided with an extremely diverse variety of retouching functionalities so as to also appeal to graphical designers and the like. However, as the retouching carried out most frequently by photo studios is more or less limited to a few particular categories, it is instead more important that they be able to carry those particular categories of retouching quickly and in routine fashion. Furthermore, as there are any number of standard sizes which may be used for printed output of commercial photographs, prior to printing it is necessary to carry out print layout operations wherein photograph size is made to conform to such a standard size and/or multiple numbers of photographs of standard size are arranged on a sheet of media. However, such print layout operations also represent an inconvenience in conventional systems. There is therefore a demand that such print layout operations be made capable of being carried out easily and in routine fashion. There is furthermore a desire to be able to carry out photo retouching operations simultaneously and in parallel fashion with respect to printing of photos which have already been retouched.

Third, the ability to manage studio business is demanded. For example, capabilities such as would permit proper management of printer status, execution history, and execution status of a multiplicity of print jobs are demanded. There is demand and desire that such management should allow prevention of interruption to printing operations caused by printer failures or the like, allow supply of consumables to take place as appropriate, allow system maintenance to take place as appropriate, and/or improve efficiency of operations for calculation of charges.

### DISCLOSURE OF INVENTION

The present invention was conceived primarily to address the second of the foregoing problems, it being an object thereof to make it possible for operations wherein print layout(s) is or are edited and print job(s) is or are created to be carried out efficiently.

A print layout editing program in accordance with a first aspect of the present invention is a computer program for editing one or more print layouts representing how one or more images to be printed is or are to be arranged on print media, the print layout editing program being capable of causing one or more computers to carry out one or more steps wherein one or more desired sets of image data are displayed and the layout on print media of at least one of the set or sets of image data is edited; and one or more steps wherein one or more sets of print job data are created, at least one of the set or sets of print job data being in accordance with at least one of the edited layout or layouts and including at least one of the desired set or sets of image data and one or more color profiles previously embedded in that image data.

In a preferred embodiment associated with the first aspect of the present invention, in the event that at least one of the desired set or sets of image data has no color profile embedded therein, at least one of the computer or computers may be further made to carry out one or more steps wherein one or more prescribed color profiles are automatically treated as if it or they had previously been embedded therein.

A layout editing program in accordance with a second aspect of the present invention is a computer program for editing one or more print layouts representing how one or more images to be printed is or are to be arranged on print media, the layout editing program being capable of causing one or more computers to carry out one or more steps wherein one or more desired templates are displayed after being selected from one or more template libraries, each of which contains a plurality of templates, each template comprising one or more image frames of prescribed size or sizes arranged at prescribed location or locations on one or more pages; one or more steps wherein a plurality of images are displayed; and one or more steps wherein one or more user-desired sets of image data corresponding to one or more images among the displayed plurality of images is or are pasted in or on one or more user-specified image frames present within at least one of the displayed template or templates so as to permit one or more print layouts to be edited.

In a preferred embodiment associated with the second aspect of the present invention, at least one of the computer or computers may be further made to carry out one or more steps wherein one or more users are able to edit one or more pages such that at least one image size can be freely set without use of the template or templates.

In a first variation on the preferred embodiment associated with the second aspect of the present invention, at least one of the computer or computers may be further made to carry out one or more steps wherein one or more packages are selected in response to user request or requests, each package representing a set comprising a plurality of templates of the same page size; one or more steps wherein a plurality of templates contained within at least one of the selected package or packages are displayed in list or table fashion; and one or more steps wherein one or more user-desired templates among the plurality of templates displayed in list or table fashion are selected and used for print layout editing of one or more pages. Moreover, at least one of the computer or computers may be further made to carry out one or more steps wherein arrangement of one or more image frames present within at least one of the template or templates can be changed in response to user request or requests.

In a second variation on the preferred embodiment associated with the second aspect of the present invention, at least one of the computer or computers may be further made to carry out one or more steps wherein, responsive to user request or requests, one or more new templates is created using one or more template creation tools, and at least one of the created template or templates is added to at least one of the template library or libraries. Moreover, at least one of the computer or computers may be further made to carry out one or more steps wherein connection or connections is or are made to one or more other computers by way of communication network or networks, and one or more of the desired template or templates are obtained from one or more template libraries at at least one of the other computer or computers; and one or more steps wherein at least one of the obtained template or templates is used to carry out print layout editing.

In a third variation on the preferred embodiment associated with the second aspect of the present invention, at least one of the computer or computers may be further made to carry out one or more steps wherein, when at least one of the image or images is to be placed in at least one of the image frame or frames, either a first or a second placement style is selected in response to user request or requests; in the event that the first placement style is selected, the at least one image is made the maximum size which will allow all of it to fit completely within the at least one image frame, margin or margins being added as necessary during placement thereof in the at least one image frame; and in the event that the second placement style is selected, the at least one image is made the minimum size which will allow it to fit within the at least one image frame without production of a margin or margins, portion or portions of the at least one image which extends or extend beyond the at least one image frame being trimmed as necessary during placement thereof in the at least one image frame.

In a fourth variation on the preferred embodiment associated with the second aspect of the present invention, at least one of the computer or computers may be further made to carry out one or more steps wherein, when one or more images which is or are long horizontally is or are to be placed in one or more image frames which is or are long vertically, and/or when one or more images which is or are long vertically is or are to be placed in one or more image frames which is or are long horizontally, at least one of the respective image or images is rotated by 90 degrees before being placed in the corresponding image frame. Moreover, at least one of the computer or computers may be further made to carry out one or more steps wherein, responsive to user request or requests, either clockwise or counterclockwise may be selected as the direction in which the at least one image is to be rotated at at least one of the rotating step or steps.

In a fifth variation on the preferred embodiment associated with the second aspect of the present invention, at least one of the computer or computers may be further made to carry out one or more steps wherein, when editing one or more print layouts for respective pages in one or more print jobs comprising a plurality of pages, a different template is applied to each page in response to user request or requests.

A layout editing program in accordance with a third aspect of the present invention is a computer program for editing one or more print layouts representing how one or more images to be printed is or are to be arranged on print media, the layout editing program being capable of causing one or more computers to carry out one or more steps wherein one or more print jobs are created based on results of editing; and, responsive to user request or requests when creating at least one of the print job or jobs, (1) one or more steps wherein instruction as to which among the plurality of printers is or are acceptable as printer or printers to be used for printing at least one of the print job or jobs is included within at least one of the print job or jobs; (2) one or more steps wherein instruction to use one specific printer among the plurality of printers as the printer to be used for printing at least one of the print job or jobs is included within at least one of the print job or jobs; and one or more steps wherein at least one of the step or steps at either (1) or (2), above, is selected.

In a preferred embodiment associated with the third aspect of the present invention, at least one of the computer or computers may be further made to carry out one or more steps wherein, in the event that at least one of the step or steps at (1) is selected, instruction to print all of the print job or jobs using the same printer or printers is included within at least one of the print job or jobs in response to user request or requests.

In a variation on the preferred embodiment associated with the third aspect of the present invention, at least one of the computer or computers may be further made to carry out one or more steps wherein, in the event that at least one of the step or steps at (1) is selected, instruction to print identical pages within at least one of the print job or jobs using the same printer or printers is included within at least one of the print job or jobs in response to user request or requests.

A layout editing program in accordance with a fourth aspect of the present invention is a computer program for editing one or more print layouts representing how one or more images to be printed is or are to be arranged on print media, the layout editing program being capable of causing one or more computers to carry out one or more steps wherein whether to print at least one of (1) one or more page borders, (2) one or more image frame borders, (3) one or more crop marks, (4) one or more customer names, (5) one or more image file names, (6) one or more computer machine names, and (7) one or more editing staffperson names, on one or more pages subject to editing is specified in response to user request or requests.

A layout editing program in accordance with a fifth aspect of the present invention is a computer program for editing one or more print layouts representing how one or more images to be printed is or are to be arranged on print media, the layout editing program being capable of causing one or more computers to carry out one or more steps wherein one or more print layouts are edited for each page constituting one or more print jobs; one or more steps wherein print job data is formed based on results of this editing; and one or more steps wherein one or more messages to the effect that printing is finished are automatically displayed when printing of one or more print jobs currently subject to editing is finished.

In a preferred embodiment associated with the fifth aspect of the present invention, at least one of the computer or computers may be further made to carry out one or more steps wherein, responsive to user request or requests, selection is made as to whether at least a portion of the print job data should be automatically saved or automatically deleted when printing thereof is finished as described above.

### BRIEF DESCRIPTION OF DRAWINGS

FIG. 1 is drawing showing a schematic example of printer and monitor gamuts.

FIG. 2 is a block diagram showing the overall constitution of an embodiment of the present invention.

FIG. 3 is a block diagram showing constitution, function, and operation at print server machine 2 and client machines 5A, 5B in photo studio system 1.

FIG. 4 is a block diagram showing constitution, function, and operation at print server machine 2 and center server machine 8.

FIG. 5 is a drawing showing retoucher main window 110 of special photo retoucher 11.

FIG. 6 is a drawing showing COLOR PROFILE SETUP dialog box 130 of special photo retoucher 11.

FIG. 7 is a flowchart showing flow of processing for setting of working ICC profile(s) at special photo retoucher 11 and for color matching using such working ICC profile(s).

FIG. 8 is a drawing showing layout editor main window 140 of layout editor 13.

FIG. 9 is a drawing showing a specific example of the layout editor main window 140 which appears in FIG. 8.

FIG. 10 is a drawing showing a specific example of the layout editor main window 140 which appears in FIG. 8.

FIG. 11 is a drawing showing a specific example of the layout editor main window 140 which appears in FIG. 8.

FIG. 12 is a drawing showing PREFERENCES dialog box 160 of layout editor 13.

FIG. 13 is an enlarged view of the display region appearing in FIG. 10 which includes media/printer selection area 146, layout selection area 147, layout display area 148, and placement style/page setup area 150.

FIG. 14 is a drawing showing a message which is displayed at layout display area 148 during switching of modes between template mode and free mode.

FIG. 15 is a drawing showing screen display at layout display area 148 when package(s) is or are employed.

FIG. 16 is a drawing showing a message which is displayed at layout display area 148 when a change is made to template information at print server machine 2.

FIG. 17 is a drawing showing a dialog box which is displayed when browse button 147E is clicked.

FIG. 18 is a drawing showing a dialog box which is displayed during confirmation of template selection and reordering.

FIG. 19 is a drawing showing layout selection area 147 and layout display area 148 as they appear after switching from template mode to free mode.

FIG. 20 is a drawing showing a message which is displayed when an image that has been dragged and dropped does not contain resolution information.

FIG. 21 is an enlarged view of the display region appearing in FIG. 11 which includes option selection area 151 and print command area 152.

FIG. 22 is a drawing showing a dialog box which is displayed when entering settings for printing of crop marks.

FIG. 23 is a drawing showing a dialog box which is displayed when entering settings for printing of photo frames.

FIG. 24 is a drawing showing a dialog box which is displayed during selection and/or editing of customer names.

FIG. 25 is a drawing showing a message which is displayed when a user or the like does not have printing privileges.

FIG. 26 is a drawing showing a message which is displayed when there is no printing paper in a cassette at printers 3A, 3B that matches the paper size and paper type selected at media/printer selection area 146.

FIG. 27 is a drawing showing a dialog box displaying a progress bar which is output during printing.

FIG. 28 is a block diagram showing functional constitution of print server machine 2 and center server machine 8 for updating printer ICC profile(s).

### BEST MODE FOR CARRYING OUT INVENTION

Before beginning description of embodiments, “color profiles” and “color matching,” repeated reference to which is made throughout such description, will be described.

Each of the various image processing devices (e.g., cameras, image scanners, display monitors, printers, etc.) has its own unique color space(s) in which operations are carried out and its own unique gamut(s), i.e., locus or loci of colors that can be created. For example, while display monitors all operate within RGB color space, gamut will vary from monitor to monitor. Likewise, gamuts of printers, which carry out operations in CMYK color space, will be different for different printers. Furthermore, even the same printer will exhibit different gamuts depending upon the type of ink and printing medium (printing paper) used therewith.

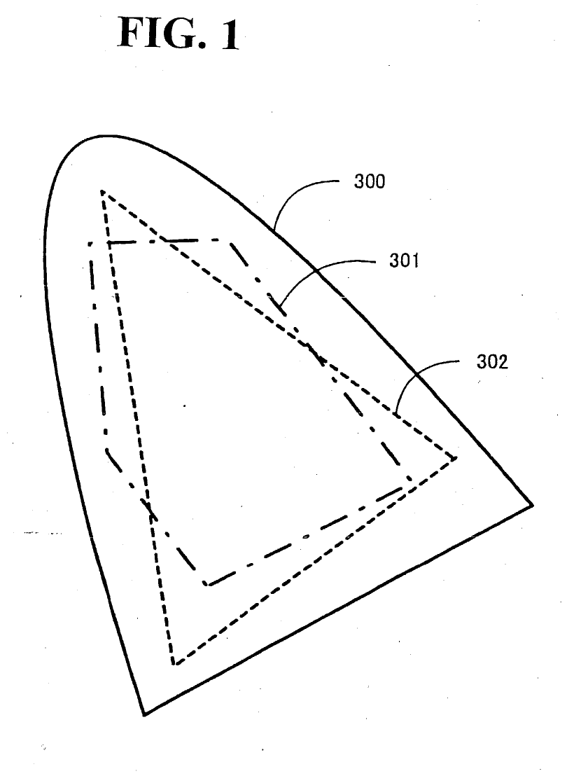

FIG. 1 is drawing showing a schematic example of gamuts of different devices. At FIG. 1, reference numeral 300 indicates gamut visibly perceivable by human beings, reference numeral 301 indicates gamut capable of being printed out by a particular printer, and reference numeral 302 indicates gamut capable of being displayed by a particular display monitor. As shown in FIG. 1, gamut varies depending on device.

An output device such as a monitor or printer is only capable of expressing colors within the range of its gamut. An input device such as a camera or image scanner is only capable of storing colors within the range of its gamut. The fact that gamut varies from device to device in this fashion means that the color space within which the device operates will vary from device to device. For example, while every printer operates within the same type of color space, i.e., CMYK, gamut will be different for each individual printer and for each ink and printing medium used therewith. There therefore exist different CMYK color spaces for each individual printer and for each ink and printing medium used therewith.

“Color profiles” refer to numerical representations used to provide rigorous definition of the color spaces within which various devices operate. A color profile includes indication of the type(s) of color space peculiar to that device (e.g., RGB, CMYK, LCH, etc.). But the primary information included as part of a color profile is conversion table(s) for conversion of color space(s) peculiar to that device (e.g., RGB, CMYK, LCH, and/or other such color spaces) to device-independent color space(s) (e.g., XYZ, Yxy, Lab, Luv, and/or other such color spaces), and/or for carrying out conversion in the reverse direction. Such conversion tables make it possible for characteristic gamuts of devices to be quantitatively defined.

The International Color Profile format established by the ICC (International Color Consortium) is a known standard for color profile format. In the description that follows, “ICC profile” refers to a color profile written in this International Color Profile format.

“Color matching,” also called “color mapping,” refers to the adjustment (shift) which must be made to color values in image data subject to conversion when converting image data in one particular color space to image data in a different color space so as to cause colors in the two color spaces to approximate one another. It is impossible to cause colors to match perfectly when going between two different color spaces if the gamuts thereof are different. But if, when converting image data of one color space to image data of a different color space, great care is exercised in shifting color values of such image data so as to compensate for the difference in gamuts between the two color spaces, it is possible to satisfactorily approximate colors in going from one of the two devices to the other. Processing for shifting color values in this way is called color matching (or color mapping).

Color matching may be carried out through use of color profiles, e.g., ICC profiles, respectively representing source (conversion input) color space(s) and target (conversion output) color space(s). For example, when converting RGB image data output from a digital camera to CMYK image data to be printed by a printer, color matching may be carried out through use of a color profile for the RGB color space of the digital camera as source, and a color profile for the CMYK color space of the printer as target. This will allow a printout to be obtained which has color(s) satisfactorily approximating color(s) as present in pictures taken with the digital camera. Alternatively, when converting RGB image data displayed on a monitor to CMYK image data to be printed by a printer, color matching may be carried out through use of a color profile for the RGB color space of the monitor as source, and a color profile for the CMYK color space of the printer as target. This will allow a printout to be obtained which has color(s) satisfactorily approximating color(s) as displayed on the monitor.

Color matching may be broadly categorized as falling into one of two categories depending upon the method used to handle colors present in the gamut of the source which lie outside of the bounds of the target gamut. In the first method, source colors lying outside of the target gamut are essentially discarded. In the second method, source colors lying outside of the target gamut are shifted so as to make them fall within the target gamut through use of interpolation processing or the like. These two methods each have advantages and disadvantages. Especially with conversion of photographic images, there is less tendency that a person looking at the post-conversion photographic image will be struck by a sense of unnaturalness if the latter color matching method is used. This latter color matching method is referred to as “perceptual color matching.”

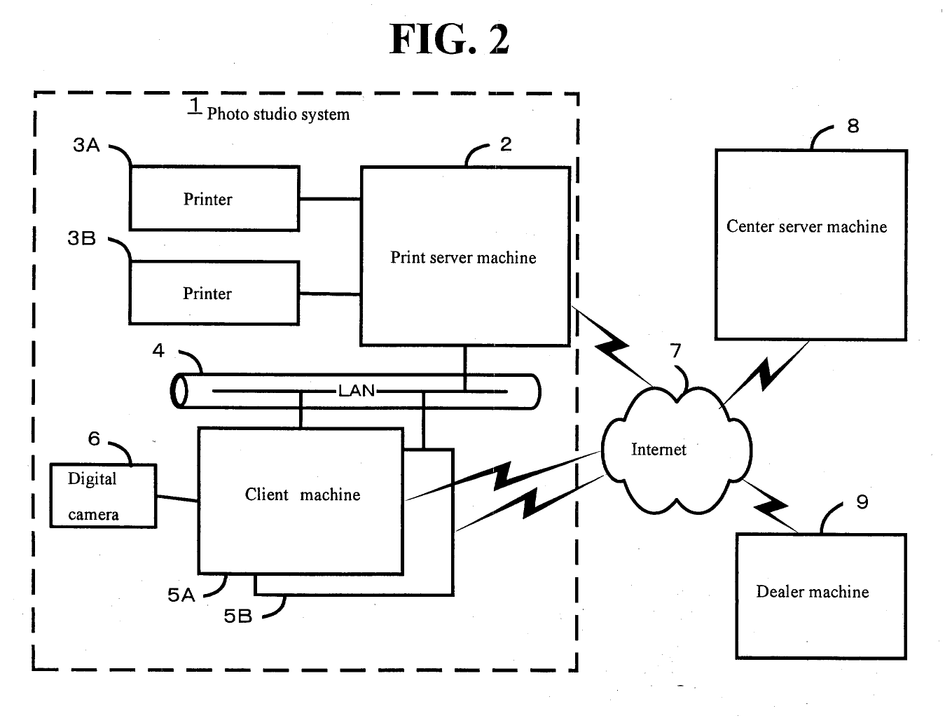

An embodiment of the present invention is described below. FIG. 2 shows the overall constitution of this embodiment.

At FIG. 2, each of a number of photo studios is equipped with photo studio system(s) 1. Present at photo studio(s) there is or are LAN(s) 4, such LAN(s) 4 connecting print server machine(s) 2 and one or a plurality of (e.g., two) computer machines (hereinafter “client machines”) 5A, 5B. Client machines 5A, 5B may connect, e.g., via USB, to digital camera(s) 6. Furthermore, one or a plurality of (here, two) electronic printers 3A, 3B is or are respectively connected, e.g., via USB, to print server machine(s) 2. Each printer 3A, 3B is an inkjet printer employing for example pigment-type inks, these being capable of producing high-quality printed output that is extremely lightfast. Print server machine(s) 2 and the two printers 3A, 3B may be housed within a single dedicated box-like casing (not shown), permitting installation at a single location somewhere at the photo studio.

Client machines 5A, 5B are primarily used to read one or a plurality of photo images from digital camera(s) 6 and store same in disk storage and for editing one or more desired photo images and generating therefrom data representing print job(s) of desired number(s) of pages and other such operations. Included among the editing of photo images carried out here are photo retouching operations wherein desired enhancements such as trimming, local modifications, global color adjustment, and/or the like are carried out on individual photo images, print layout editing wherein one or more desired photo images is or are arranged so as to occupy the space on a sheet of media (printed page), and so forth. Print server machine(s) 2, on the other hand, possesses or possess the ability to accept print job data from client machines 5A, 5B and to create respective page(s) of printed image(s) based thereon and send same to printers 3A, 3B. Furthermore, print server machine(s) 2 possesses or possess the ability to manage status, print job execution status and execution history, and other such information (hereinafter “print information”) pertaining to printers 3A, 3B, and to communicate same to client machines 5A, 5B.

Moreover, existing separate from the photo studio(s) there is or are center server machine(s) 8, whose role it is to centrally manage operational status of photo studio systems 1 at a multiplicity of photo studios. Print server machines 2 and client machines 5A, 5B at respective photo studio systems 1 may respectively communicate with center server machine(s) 8 via the Internet 7. Center server machine(s) 8 gather print information for respective photo studios from print server machines 2 of the photo studio systems 1 thereof, this being stored in database(s) of center server machine(s) 8, where it is managed. Upon being logged onto by way of WWW browser(s) by user(s) at respective photo studios, center server machine(s) 8 may provide such a WWW browser with print information for that photo studio as stored in database(s) of center server machine(s) 8. Furthermore, when information indicating occurrence of prescribed event(s) previously specified by user(s) at respective photo studios (e.g., a printer paper jam or other such error) is received from such a photo studio, center server machine(s) 8 may transmit such fact by electronic mail to email address(es) previously specified by such a user (e.g. an email address for a mobile phone belonging to such a user). In addition, center server machine(s) 8 may, based on print information from respective photo studios, calculate consumed quantity or quantities of paper, ink, and/or other such consumables at such a photo studio and may make arrangements for supply of consumables to respective photo studios, carry out billing for amounts in connection therewith, and so forth.

Furthermore, in one mode of photo studio business management, intermediate management organization(s) (hereinafter “dealer(s)”) might be interposed between center(s) and the several photo studios, each dealer managing business from a plurality of photo studios. In such a case, each dealer would also have computer machine(s) (hereinafter “dealer machine(s)”) 9 whereon WWW browser(s) and/or the like is or are installed. Moreover, upon being logged onto by way of WWW browser(s) by respective dealers, center server machine(s) 8 may provide such a WWW browser with print information for photo studio(s) whose account(s) is or are handled by such a dealer. Dealer machine(s) 9 may take the place of center server machine(s) 8 in making arrangements for supply of consumables to respective photo studios, billing for amounts in connection therewith, and so forth based on print information for respective photo studios.

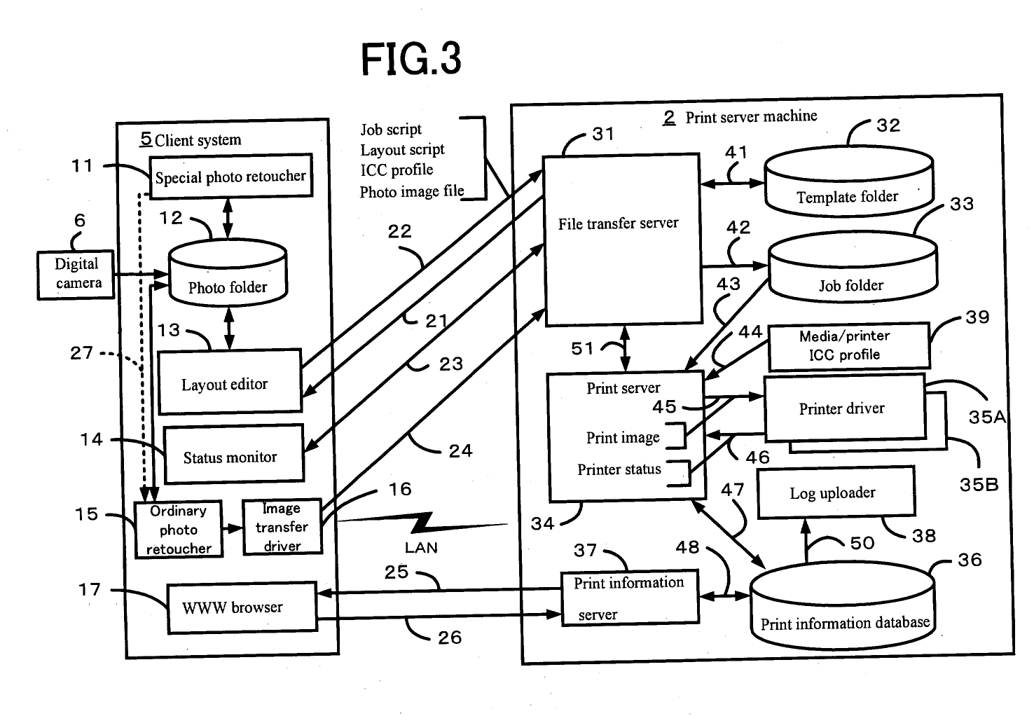

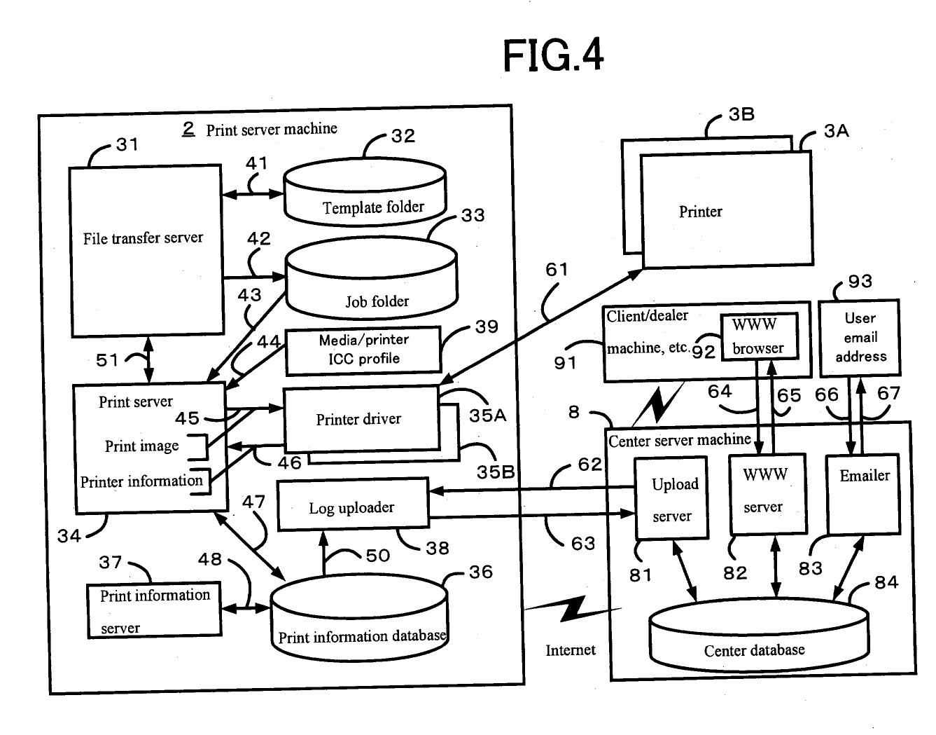

Below, constitution and function of the various machines mentioned above will be described in further detail with reference to FIG. 3 and FIG. 4. FIG. 3 shows constitution and function at print server machine 2 and client machines 5A, 5B in photo studio system 1. FIG. 4 shows constitution and function at print server machine 2 and center server machine 8. By looking at FIG. 3 and FIG. 4 together, the relationship among the various machines with respect to exchange of information therebetween will become clear.

Referring first to FIG. 3, constitution and function of client machines 5A, 5B will be described. Note that at FIG. 3, client machines 5A, 5B are indicated collectively by the single block of client system 5. The number of client machines contained at client system 5 need not be two as in the present embodiment, it being possible to employ any number so long as there is one or more thereof. Furthermore, the plurality of application programs 11 through 17 such as will be described below which client system 5 possesses may be installed on all of the client machines comprised by client system 5 or may be installed on any one machine only, or may be installed in distributed fashion such that one program is for example installed on client machine 5A, another program is for example installed on client machine 5B, and so forth.

As shown in FIG. 3, a plurality of application programs, including special photo retoucher 11, layout editor 13, status monitor 14, ordinary photo retoucher 15, image transfer driver 16, and WWW (World Wide Web) browser 17, are installed at client system 5. Moreover, a program for sending and receiving electronic mail (not shown) may also be installed at client system 5.

Special photo retoucher 11, being a specially designed photo retouching program for photo studio use, is constituted so as to permit prescribed retouching tasks typically required at photo studios to be carried out efficiently and in routine fashion.

When beginning retouching operations on respective photo image(s), this special photo retoucher 11 automatically (always, unless otherwise requested by the user) causes ICC color profile(s) to be set which indicates or indicate color space(s) in which those retouching operations are to be carried out. The user may specify the type of color space(s) for which ICC color profile(s) is or are to be set. But where there is no specific specification from user(s), special photo retoucher 11 will always cause ICC color profile(s) to be set in accordance with default settings. Furthermore, when outputting photo image(s) after retouching thereof is finished, special photo retoucher 11 embeds such ICC profile(s) (meaning ICC color profile(s), here and below) in file(s) containing such photo image(s).

Note that color space(s) in which photo image editing operations are carried out prior to printing, such as color space(s) in which this special photo retoucher 11 carries out retouching operations or color space(s) in which layout editor 13, described next, carries out print layout editing operations, will hereinafter be referred to as “working color space(s)” for such photo images. Note also that ICC profile(s) indicating such working color space(s) will hereinafter be referred to as “working ICC profile(s).”

Layout editor 13, being an application program for print layout editing intended for photo studios, is designed to permit print layout editing operations, wherein one or more photo images is or are arranged so as to occupy printed page(s) (the space(s) on sheet(s) of print media) with size(s) of respective photo image(s) being made to conform to desired standard size(s), to be carried out quickly and in routine fashion. That is, as indicated by arrow 21, layout editor 13 reads from print server machine 2 a multiplicity of templates respectively representing various basic print layouts previously prepared and made available at print server machine 2, and displays template(s) desired by user(s) at monitor(s) of client system 5. The basic print layouts represented by the respective templates are space(s) (print page(s)) of standard print media size(s) capable of being used by printer(s), e.g., A4, A3, or B4, etc., in landscape (horizontal) or portrait (vertical) orientation, wherein one or a plurality of photo frame(s) of standard photo size(s), e.g., 8×10 inch, 5×7 inch, 2.5×3.5 inch, or 1.75×2.5 inch, is or are arranged. Many templates are such that photo frame(s) is or are efficiently arranged so as to make sufficiently small the total area outside of photo frame(s) in order to make economic use of print media. By using graphical user interface(s) of layout editor 13 to drag and drop desired photo image(s) onto desired respective photo frame(s) within template(s), user(s) can cause print page layout editing to be carried out automatically.

When beginning print layout editing operations on respective photo image(s), layout editor 13 also causes working ICC profile(s) for working color space(s) in which such operations are to be carried out to be set for such photo image(s),. If particular ICC profile(s) has or have previously been embedded in such photo image(s), layout editor 13 uses such embedded ICC profile(s) as working ICC profile(s). Because image(s) which has or have, for example, been subjected to retouching by special photo retoucher 11 will already have embedded therein ICC profile(s) for color space(s) in which special photo retoucher 11 operated, this means that layout editor 13 will operate in exactly the same color space(s) as the color space(s) in which special photo retoucher 11 operated. If, on the other hand, such photo image(s) does or do not yet have ICC profile(s) embedded therein, layout editor 13 automatically guesses at ICC profile(s) which it assumes to have been previously embedded in such photo image(s), using such assumed ICC profile(s) as working ICC profile(s). User(s) may specify exactly what ICC profile(s) is or are to be assumed in such a case. But where there is no specific specification from user(s), layout editor 13 will automatically use specific ICC profile(s) which has or have been set by default as the ICC profile(s) which it assumes and uses as if previously embedded in such photo image(s). Furthermore, when outputting photo image(s) after print layout editing is finished, layout editor 13 embeds working ICC profile(s) automatically set as described above in file(s) containing such photo image(s).

Upon completion of editing of the layout of all print pages constituting a single print job, layout editor 13 creates data for that print job, which is transferred to print server machine 2 as indicated by arrow 22. Such print job data includes data indicating layout of all print page(s) contained within that print job, file(s) containing all photo image(s) to be placed on such print page(s), and working ICC profile(s) embedded in such photo image file(s).

Layout editor 13 is made available as an independent program separate from retouching program(s) such as the special photo retoucher 11, described above, or the ordinary photo retoucher 15, described below. Moreover, client machines 5A, 5B, whereon such programs are installed, are connected by way of LAN 4 so as to permit mutual sharing of data, programs, and other such resources. This makes it possible for studio business to proceed efficiently and in such manner as to permit one user at a studio to for example use one client machine 5A to carry out photo retouching operations with retouching program 11 or 15 on photo image(s) acquired from digital camera(s) 6, while in parallel fashion with respect thereto another user might use the other client machine 5B to carry out print layout editing operations with layout editor 13 on photo image(s) which has or have already been retouched. Furthermore, if there are three or more client machines, this will allow studio business to proceed in all the more flexible and efficient fashion.

As indicated by arrow 23, status monitor 14 obtains the most recent history information pertaining to errors generated by printers 3A, 3B and completion of execution (completion of printing) of respective print jobs from print server machine 2 at time intervals (e.g., every 10 minutes, etc.) previously set by user(s), displaying same on display monitor(s) of client system 5.

Ordinary photo retoucher 15, being a conventionally known ordinary photo retouching program, is provided not only with retouching functionalities typically required at photo studios but also with a diverse variety of retouching functionalities capable of satisfying graphical designers and the like. With respect to tasks within the bounds of retouching typically performed at photo studios, special photo retoucher 11, described above, is designed to allow operations to proceed more efficiently than would be the case with ordinary photo retoucher 15. But in the event of a desire to perform atypical retouching not supported by special photo retoucher 11, user(s) may use ordinary photo retoucher 15 instead of special photo retoucher 11.

Special photo retoucher 11, described above, is designed to permit retouching operations to be performed in cooperation with ordinary photo retoucher 15. That is, special photo retoucher 11 has button(s) on its graphical user interface for launching ordinary photo retoucher 15. Moreover, if such button(s) is or are pressed by user(s) while retouching operations are underway on particular photo image(s), special photo retoucher 11 automatically assigns specific file name(s) to and saves the photo image(s) on which operations were underway, storing such file name(s), and furthermore, as indicated by arrow 27, launches ordinary photo retoucher 15 and informs ordinary photo retoucher 15 of such file name(s), causing such photo image(s) to be opened therein. In addition, special photo retoucher 11 itself becomes inactive. Upon termination of ordinary photo retoucher 15 thereafter, special photo retoucher 11 automatically becomes active again, reopening the photo image file(s) having the file name(s) which was or were stored. As a result, if the photo image(s) passed from special photo retoucher 11 to ordinary photo retoucher 15 as described above is or are stored with the same file name(s) prior to termination of ordinary photo retoucher 15, this means that special photo retoucher 11 will automatically reopen that or those photo image file(s), permitting resumption of continued retouching operations thereon. Combination of special photo retoucher 11 and ordinary photo retoucher 15 in this way makes it possible for retouching operations to proceed efficiently. Moreover, when photo image(s) is or are passed from special photo retoucher 11 to ordinary photo retoucher 15, because there is no guarantee that working ICC profile(s) of such photo image(s) would be preserved by ordinary photo retoucher 15, special photo retoucher 11 discards such working ICC profile(s). Furthermore, when reopening such photo image file(s), special photo retoucher 11 again causes working ICC profile(s) to be set.

Image transfer driver 16, launched at time(s) of print request(s) from ordinary photo retoucher 15, creates print job data for photo image(s) open in ordinary photo retoucher 15 and transfers same to print server machine 2, as indicated by arrow 24.

WWW browser(s) 17 is or are program(s) for accessing various WWW servers available over the Internet 7 or LAN(s) 4. First among the ways in which WWW browser(s) 17 may be used in connection with photo studio business is for connecting to print information server(s) (such a server representing a type of WWW server) 37 of print server machine 2 and, as indicated by arrows 25 and 26, accessing status, print job execution history, and other such printer information for printers 3A, 3B which is managed by print server machine 2. Second, as indicated by arrow 65 of FIG. 4, is for connecting to WWW server(s) 82 of center server machine(s) 8 and accessing printer information or the like for such photo studio(s) which is managed by center server machine(s) 8.

Next, referring to FIG. 3 and FIG. 4, function and constitution of print server machine 2 will be described.

As shown in FIG. 3 and FIG. 4, programs including file transfer server 31, print server 34, printer drivers 35A, 35B, print information server 37, and log uploader 38, are installed at print server machine 2.

File transfer server 31 possesses a multiplicity of templates for use in print layout editing and carries out processing for providing such templates to layout editor 13 of client system 5, processing for accepting print job data from image transfer driver 16 and/or layout editor 13 of client system 5 and for transferring same to print server 34, processing for sending to status monitor 14 of client system 5 information concerning the situation with respect to occurrence of errors, termination of execution of print jobs, and so forth at printers 3A, 3B which is provided by print server 34, and so forth.

This file transfer server 31 possesses templates for a variety of basic print layouts previously prepared and made available at template library folder 32 within disk storage at print server machine 2. Furthermore, when specific template(s) is or are requested by layout editor 13 of client system 5, file transfer server 31 reads the requested template(s) from template library folder 32 as indicated by arrow 41, and transfers same to layout editor 13 as indicated by arrow 21. Utilization of such templates facilitates print layout editing at layout editor 13. It is possible to make use of the shared templates which are centrally managed by print server machine 2 no matter which client machine 5A, 5B is or are being used to carry out print layout editing.

Furthermore, file transfer server 31 receives print job data from image transfer driver 16 and/or layout editor 13 of client system 5 as indicated by arrow 22 (and/or 24), and stores such print job data in job folder 33 within disk storage at print server machine 2 as indicated by arrow 42. As shown in the drawing, the print job data from layout editor 13, indicated by arrow 22, comprises job script(s) for such print job(s), layout script(s) for one or more pages included within such print job(s), file(s) containing one or a plurality of photo image(s) included within such print job(s), and working ICC profile(s) for such photo image(s). What is here referred to as a job script is or are file(s) containing description of item(s) necessary for management of such print job(s); e.g., user name(s), printing priority, number of copies to be printed, designation of type(s) (material(s)) and size(s) of print media, designation of printer(s), time stamp(s) for such print job(s), and/or the like. What is here referred to as a layout script is or are file(s) containing description of item(s) necessary for determining print layout on such respective print page(s); e.g., template number(s), name(s) of file(s) containing photo image(s) to be placed in respective photo frame(s) on respective template(s), settings for print options (e.g., printing of crop mark(s), file name(s), etc.), and/or the like. To reduce print job data volume, each photo image file is as a rule sent only once in a single print job data transmission regardless of how many of such photos are to be printed. Working ICC profile(s) embedded in respective photo image file(s), as described above, indicate working color space(s) in which editing operations were carried out on such photo image(s) at client system 5.

Furthermore, upon receipt of request(s) from status monitor 14 of client system 5 for history information, file transfer server 31 communicates same to print server 34 as indicated by arrow 23, and moreover, receives history information pertaining to printer errors and completion of print jobs sent thereto from print server 34 responsive to such request and transfers same to status monitor 14 of client system 5 as indicated by arrow 23.

Print server 34 carries out processing for creating print image data for respective page(s) from print job data, processing for assignment of respective set(s) of print image data to printer(s) 3A and/or 3B and for sending such set(s) of print image data to printer driver(s) 35A and/or 35B for printer(s) to which it or they was or were assigned, processing for managing status and print job execution history of printer(s) 3A and/or 3B as provided by printer driver(s) 35A and/or 35B, and so forth. Printer drivers 35A, 35B—respectively corresponding to printers 3A, 3B—carry out processing for converting print image data received from print server 34 into data of such form as to permit processing thereof by printers 3A, 3B and for sending same to printers 3A, 3B, processing for monitoring status of printers 3A, 3B and communicating same to print server 34, and so forth.

Print server 34 reads print job data for respective print job(s) from job folder 33 as indicated by arrow 43. As previously mentioned, print job data includes job script(s) for such print job(s), layout script(s) for print page(s), photo image file(s), and working ICC profile(s) for photo image(s). Print server 34 uses layout script(s) for respective print page(s) included within such print job data, and uses file(s) containing photo image(s) placed on respective print page(s), to create print image data for respective print page(s) with layout(s) as edited by user(s).

In creating print image data for respective print page(s), print server 34 reads such job script(s) and ascertains the printer(s) and print media (hereinafter “output printer(s)” and “output media”) type(s) to be used for printing such print page(s). In addition, as indicated by arrow 44, print server 34 reads, from prescribed folder 39 at print server machine 2, ICC profile(s) (hereinafter “printer ICC profile(s)”) indicating color space(s) (hereinafter “printer color space(s)”) in which such output printer(s) 3A and/or 3B is or are to carry out printing operations using such output media. Previously saved within such folder 39 are different printer ICC profiles for each type of print media respectively capable of being used with printer 3A and printer 3B. Furthermore, printer ICC profiles for all printers of all photo studios are stored at center server machine 8, print server machine(s) 2 of respective photo studio(s) being capable of downloading printer ICC profile(s) for printer(s) 3A, 3B at such photo studio(s) from center server machine 8 by designating, for center server machine 8, machine number(s) for such printer(s) 3A, 3B (such machine numbers being identification numbers unique to the individual printers).

After reading printer ICC profile(s) corresponding to output printer(s) and output media from folder 39 as described above, print server 34 uses the printer ICC profile(s) which was or were read and working ICC profile(s) for respective photo image(s) on respective print page(s) to carry out perceptual color matching on respective set(s) of photo image data. This permits respective set(s) of photo image data to be adjusted so as to produce color(s) when printed out that is or are as close as possible to the color(s) present during editing thereof. In addition, print server 34 uses such adjusted photo image data to create print image data for respective print page(s). Print server 34 thereafter sends the created print image data for respective print page(s) to printer driver(s) 35A and/or 35B corresponding to output printer(s) as indicated by arrow 45. Printer drivers 35A, 35B respectively convert print image data (e.g., RGB-type bitmapped image data) received from print server 34 into print data of such form as to permit processing thereof by printers 3A, 3B (e.g., carrying out color conversion from RGB to CMYK, halftoning, division into bands, addition of required control information, etc.), and send the created print data to the corresponding printer(s) 3A, 3B as indicated by arrow 61 in FIG. 4.

Furthermore, at appropriate time or times, printer driver(s) 35A, 35B acquires or acquire from corresponding printer(s) 3A, 3B the status (e.g., operational status, error status, consumables status, etc.) of printer(s) 3A, 3B and sends or send acquired printer status to print server 34 as indicated by arrow 46. Print server 34 ascertains status with respect to execution of print job(s) sent to printer driver(s) 35A, 35B based on the printer status received from printer driver(s) 35A, 35B. Furthermore, as indicated by arrow 47, print server 34 writes ascertained status of printer(s) 3A, 3B, print job execution status, and other such information to print information database 36 at print server machine 2. As a result, a history of the status of printers 3A, 3B and a history of executed print jobs come to be stored at print information database 36. Moreover, studio user registration information is also managed at print information database 36.

Furthermore, upon receipt of information request(s) from status monitor 14 of client system 5 via file transfer server 31 as indicated by arrow 51, print server 34 as indicated by arrow 47 reads from print information database 36 that information within the error history and history of completed print jobs for printer(s) 3A, 3B which is most recent and has not yet been communicated to client system 5, and sends same to file transfer server 31 as indicated by arrow 51. As has already been described, this most recent error history and history of print jobs for which execution has been completed are immediately transferred to status monitor 14 of client system 5 and are displayed at display monitor(s) of client system 5.

Print information server 37 is a type of WWW server, and upon being logged onto (arrow 26) by an entity having registered user privileges from WWW browser 17 of client system 5, print information server 37 creates web page(s) respectively displaying content such as studio user registration information, printer status history or histories, and/or print job execution history or histories stored at print information database 36, and provides same to such WWW browser 17 as indicated by arrow 25. Furthermore, print information server 37 also has print job history search capability or capabilities, and may receive search request(s) from user(s) from WWW browser 17, may search print information database 36 for print job history or histories requested by user(s), and may return search results to WWW browser 17. Moreover, print information server 37 also has print job control capability or capabilities, receiving control request(s) (e.g., for deletion, changes in priority, number of copies to be printed, and/or other such particulars of job content, etc.) from user(s) from WWW browser 17 for print job(s) waiting to be printed and altering information for such print job(s) within print information database 36. In addition, print information server 37 also has user registration capability or capabilities, and upon being logged onto from WWW browser 17 by an entity having administrator privileges at such photo studio, may register new user information with print information database 36.

Log uploader 38 reads new print information not yet sent to center server machine 8 from print information database 36 at regular intervals (and/or as needed, as the case may be) in accordance with upload schedule(s) (time(s), time interval(s), etc. at which uploading is to be carried out) previously specified by center server machine 8, and uploads same to center server machine 8 as indicated by arrow 63 in FIG. 4.

Furthermore, log uploader 38 has a WATCHDOG MODE for immediately reporting to user(s) abnormalities at photo studio system(s) 1 occurring when user(s) is or are absent or the like. A user wishing to make use of WATCHDOG MODE registers in advance with log uploader 38 the type(s) of abnormality to be reported (e.g., various categories of printer errors, etc.) and email address(es) (e.g., email address(es) for user mobile phone(s)) as desired by the user. Log uploader 38 communicates such registered email address(es) to center server machine 8. By putting log uploader 38 into watchdog mode at time(s) such as when such user(s) will be away from photo studio(s) or the like, upon occurrence of the specified abnormality or abnormalities log uploader 38 immediately communicates the fact of occurrence of such abnormality or abnormalities to center server machine 8. Upon receipt thereof, center server machine 8 creates email reporting occurrence of such abnormality or abnormalities, which it sends to such registered email address(es). This makes it possible for user(s) to be made quickly aware of abnormalities occurring at studio(s) of user(s) even when such user(s) is or are away from such studio(s).

Next, referring to FIG. 4, constitution and function of center server machine 8 will be described.

As shown in FIG. 4, application programs including upload server 81, WWW server 82, and emailer 83 are installed at center server machine 8.

Upload server 81, as indicated by arrow 62, communicates, to log uploader(s) 38 of respective photo studio(s), upload schedule(s) (time(s), time interval(s), etc. at which uploading is to be carried out) managed by center database 84, each studio having its own upload schedule(s), and moreover, receives the most recent print information for such studio(s) sent thereto from log uploader(s) 38 of respective studio(s) in accordance with such upload schedule(s) and stores same at center database 84 of center server machine 8.

Furthermore, at time or times when communication of occurrence of abnormality or abnormalities is received from log uploader(s) 38 of respective studio(s) while in watchdog mode, described above, upload server 81 immediately passes such communication of occurrence of abnormality or abnormalities to emailer 83 by way of center database 84. Upon receipt thereof, emailer 83 immediately creates email reporting occurrence of such abnormality or abnormalities, which it sends, as indicated by arrow 67, to previously registered email address(es) 93 as desired by user(s). This makes it possible for user(s) to be made quickly aware of abnormalities occurring at studio(s) of user(s) even when such user(s) is or are away from such studio(s).

Upon being logged onto from WWW browser 92 installed at some computer machine(s) 91 (e.g., client machine(s) 5A, 5B, dealer machine(s) 9, or other such computer(s), PDA(s), mobile phone(s), and/or the like) by an entity having user, dealer, system-wide administrator privileges, or the like, WWW server 82 reads from center database 84 print information, user information, and/or the like of a range commensurate with privileges with which such entity is logged on thereto, creates web page(s) displaying such information, and sends same to such WWW browser 92 as indicated by arrow 65. What is here referred to as a range commensurate with privileges with which such entity is logged on thereto might for example in the case of user privileges mean “extending only to photo studio(s) of such user(s) and only to such user(s),” or might in the case of dealer privileges mean “extending only to photo studio(s) whose account(s) is or are handled by such dealer(s) and only to user(s) included in such account(s),” or might in the case of system-wide administrator privileges mean “extending to all photo studio(s) and to all user(s).”

Furthermore, also managed by center database 84 in addition to print information and user information of respective photo studio(s) is a variety of information including amounts of consumables used at respective studio(s) as calculated by the center and amounts billed by the center, various news-type communications issued by the center, and so forth. Such information is also communicated to respective user(s) and respective dealer(s) by WWW server 82 and/or emailer 83.

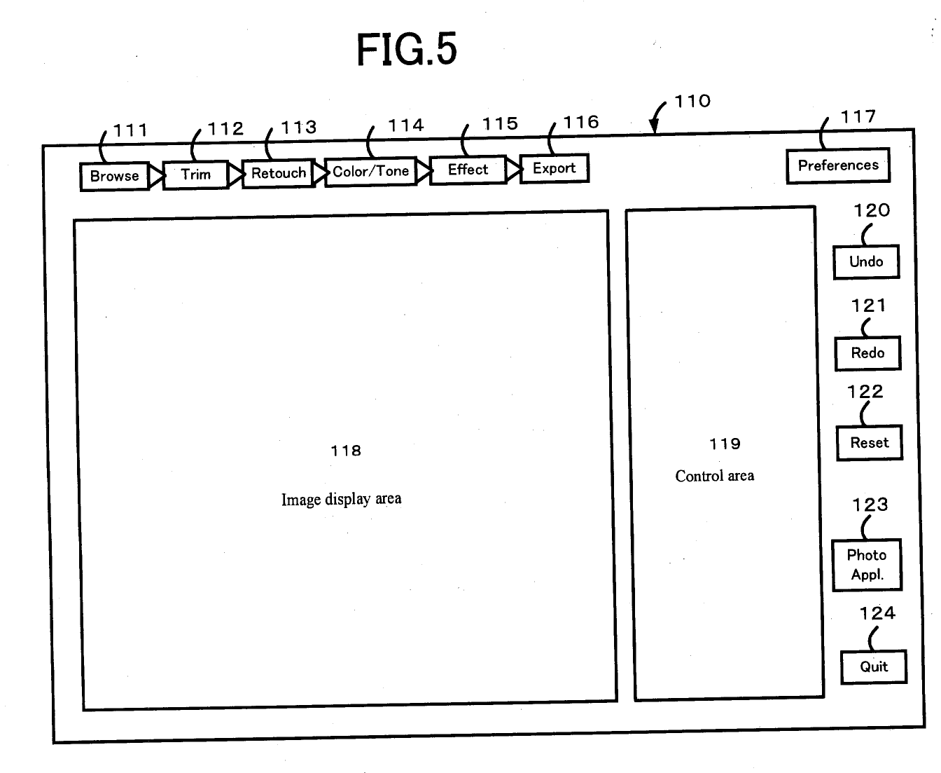

Next, referring to FIG. 3 and FIG. 4, and also to FIG. 5 and following FIGS., operation of photo studio system(s) 1 and center server machine 8 will be described in detail.

First, operation of photo studio system 1 will be described more or less following the sequence of operations at a photo studio.

As shown in FIG. 3, file(s) containing (e.g., JPEG format or TIFF format) photo image(s) taken by digital camera(s) 6 is or are acquired by client system 5 via for example USB from digital camera(s) 6, and is or are stored in user-designated photo folder(s) 12 at client system 5.

Special photo retoucher 11 and/or ordinary photo retoucher 15 is or are launched by user(s) in order to carry out photo retouching operations. The description below applies to the case where special photo retoucher 11 is launched.

Special photo retoucher 11 displays graphical user interface(s) (hereinafter “retoucher main window”) 110 such as is shown at FIG. 5 at monitor(s) of client system 5. As shown at FIG. 5, arrayed from left to right at the upper portion of retoucher main window 110 are BROWSE button 111, TRIM button 112, RETOUCH button 113, COLOR/TONE button 114, EFFECT button 115, and EXPORT button 116. The order of arrayal of these buttons 111 through 116 from left to right parallels retouching operational procedure as typically carried out by a user. Such operational procedure is more or less as follows.

To wit, firstly, if BROWSE button 111 is pressed, BROWSE mode is entered, wherein thumbnail images of all of the photo image files within desired photo folder(s) 12 may be browsed and desired photo image file(s) may be selected therefrom. Next, if TRIM button 112 is pressed, TRIM mode is entered, wherein photo image(s) selected while in BROWSE mode may be displayed in its or their entirety and unwanted region or regions other than region or regions of such image(s) which is or are desired to be printed may be cropped away so as to extract only the region or regions of such image(s) which is or are desired to be printed. Next, if RETOUCH button 113 is pressed, RETOUCH mode is entered, wherein desired brush(es) may be used to apply desired modifications at desired location(s) within such photo image(s). Next, if COLOR/TONE button 114 is pressed, COLOR/TONE mode is entered, wherein color adjustment filter(s) may be used to apply desired color adjustment(s) to entire photo image(s). Next, if EFFECT button 115 is pressed, EFFECT mode is entered, wherein special effects filter(s) may be used to apply desired special effect(s) to entire photo image(s). Note that the various types of image processing carried out on photo image(s) at the foregoing TRIM through EFFECT modes is hereinafter referred to as “enhancement.”

Lastly, if EXPORT button 116 is pressed, EXPORT mode is entered, wherein file(s) containing such photo image(s) may be saved to desired photo folder(s) 12. Among the ways in which saving may be carried out are two user-selectable methods, one of which is a method wherein photo image file(s) resulting from application to the original photo image(s) of all enhancements carried out at TRIM through EFFECT modes is or are saved, and the other of which is a method wherein file(s) containing description of parameters for all enhancements carried out at TRIM through EFFECT modes is or are saved without any change having been made to the original photo image file(s).

Routinely selecting one mode after the other from BROWSE mode to EXPORT mode and carrying out operations as described above permits facilitation of retouching operations. Furthermore, there is less chance of forgetting to carry out an enhancement which was supposed to have been done. Furthermore, while carrying out operations within the respective modes, at retoucher main window 110 shown in FIG. 5, photo image(s) subject to processing during that step or those steps is or are displayed in image display area 118, and a variety of indicators indicating processing status as well as various tools and console buttons used during that step or those steps are displayed in control area 119.

At the initial BROWSE mode, special photo retoucher 11 automatically (always, unless otherwise requested by the user) causes working ICC profile(s) to be set for photo image(s). The user may personally change working ICC profile settings. But if there is no special specification from the user, special photo retoucher 11 will automatically cause working ICC profile(s) to be set in accordance with default settings. Working ICC profile(s) set at BROWSE mode will be applied to photo image(s) selected while in BROWSE mode when processing proceeds from BROWSE mode to TRIM mode.

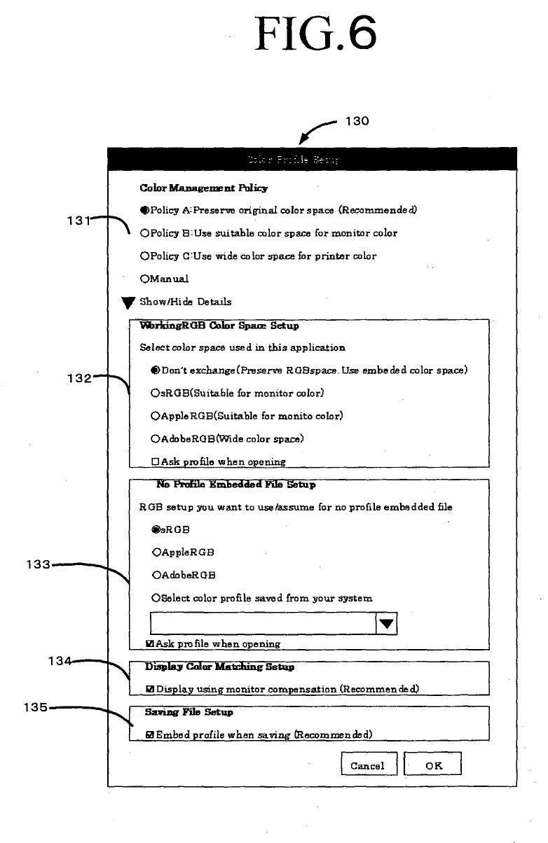

To personally set working ICC profile(s) and/or confirm current settings, a user presses PREFERENCES button 117 within retoucher main window 110 while in BROWSE mode. Upon so doing, a COLOR PROFILE SETUP dialog box 130 such as is shown in FIG. 6 is displayed in popup fashion. Note that default profile settings are shown in the example of FIG. 6. At this COLOR PROFILE SETUP dialog box 130, a user may select from among three predetermined color management policies A through C at COLOR MANAGEMENT POLICY field 131. Special photo retoucher 11 will cause working ICC profile(s) to be set which has or have preprepared parameters in correspondence to policy or policies selected here by the user.

The foregoing three policies A through C are such as will now be described.

Policy A causes ICC profile(s) previously embedded in such photo image file(s) to be employed as working ICC profile(s). (While this is not the case for the commonly available types of digital camera,) high-quality digital cameras of the type used by photo studios embed ICC profile(s) indicating the color space(s) of that digital camera in files containing photo images taken therewith and output such files (but note that the majority of the commonly available types of digital camera do not embed an ICC profile). Accordingly, by selecting policy A it is possible to use a color space of a digital camera 6 as a working color space for retouching. In other words, policy A represents settings for when it is desired to print as faithful as possible to the original color of photos taken with a digital camera 6; however, there is no guarantee that colors will be good approximations of each other in going between monitor and printer. Note further that this is the default setting.

Policy B represents settings for when it is desired to print so as to be faithful to the color displayed at monitor(s). For example, the ICC profile of the publicly known “sRGB” color space, corresponding to the color space of a typical monitor, might be set as a working ICC profile. This setting will permit color matching to be carried out between monitor and printer in comparatively proper fashion. In other words, this will allow printout color(s) to be made a good approximation of color(s) displayed at monitor(s).

Policy C causes a standard ICC profile widely employed in the industry—e.g., the ICC profile of the publicly known “AdobeRGB” color space, a wide-gamut standard which is close to printer color space and which has a wider gamut than monitor color space—to be set as a working ICC profile.

Furthermore, by selecting MANUAL at COLOR MANAGEMENT POLICY field 131 of FIG. 6, a user may use fields 132 through 135 therebelow to set desired ICC profile(s) as working ICC profile(s).

First, at WORKING RGB COLOR SPACE SETUP field 132, working ICC profile(s) may be specifically designated. Selecting DON'T EXCHANGE here causes ICC profile(s) previously embedded in such photo image(s) to be employed as working ICC profile(s). Furthermore, respectively selecting “sRGB,” “AppleRGB,” or “AdobeRGB” causes an ICC profile for the publicly known color space of same name to be set as a working ICC profile.

Furthermore, at NO PROFILE EMBEDDED FILE SETUP field 133, it is possible to set color space(s) to be assumed and used as if it or they were the original ICC profile(s) of photo image(s) in the event that ICC profile(s) is or are not yet embedded in file(s) containing such photo image(s) (e.g., there is often no ICC profile embedded in photo image files acquired from commonly available types of digital cameras). The default setting is “sRGB.” “sRGB,” “AppleRGB,” “AdobeRGB,” or any arbitrary ICC profile managed by a color management system at client system 5 may be selected and set in correspondence to user preference.

Furthermore, by placing a check mark in the box next to ASK PROFILE WHEN OPENING (this being the default setting), when any arbitrary photo image file(s) is or are opened (photo image file(s) selected while in BROWSE mode being, for example, opened when processing proceeds from BROWSE mode to TRIM mode), special photo retoucher 111 will force prescribed dialog box(es) for confirming and setting working ICC profile(s) to be displayed in popup fashion if ICC profile(s) is or are not yet embedded in such photo image file(s). This makes it possible for user(s) to never forget to confirm the type of working ICC profile(s) to be set for photo image(s) in which ICC profile(s) is or are not embedded.

As described above, special photo retoucher 11 always sets working ICC profiles for photo images at the initial BROWSE mode.

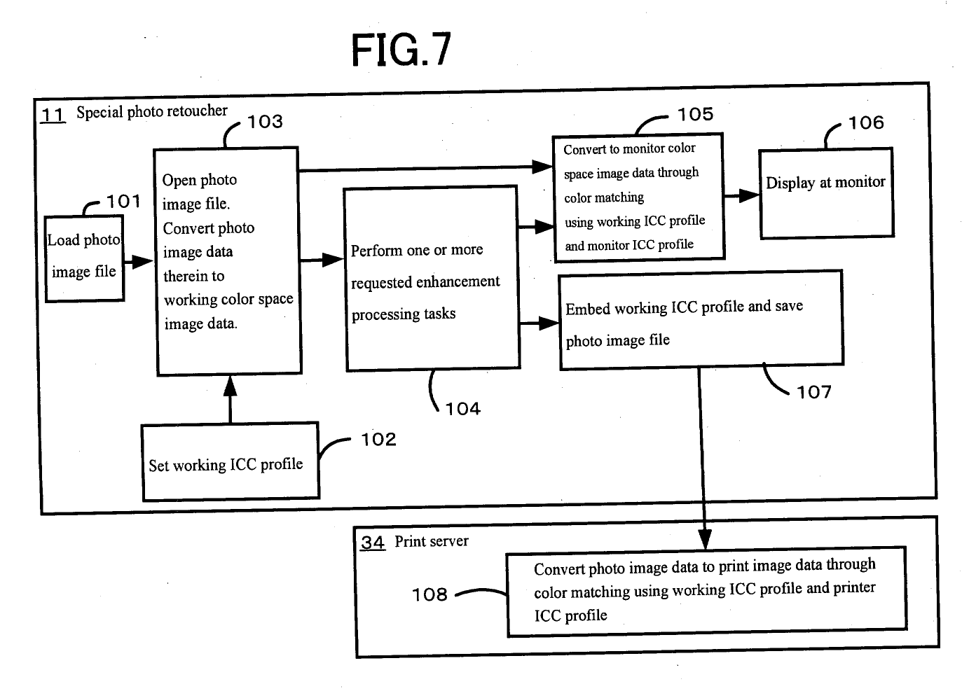

FIG. 7 shows flow of processing for setting working ICC profile(s) at special photo retoucher 11 as described above, and for using such working ICC profile(s) during color matching between working color space(s) and color space(s) of monitor(s) and/or printer(s) which is carried out thereafter.

At FIG. 7, step 102 indicates setting of working ICC profile(s) in BROWSE mode, described above. Thereafter, when processing proceeds from BROWSE mode to TRIM mode, special photo retoucher 11 reads photo image file(s) selected while in BROWSE mode as indicated at step 101, and opens such photo image file(s) as indicated at step 103. When such photo image file(s) is or are opened, the photo image data thereof may be converted to image data belonging to working color space(s) defined by working ICC profile(s) set at BROWSE mode. At such time(s), if ICC profile(s) previously embedded in such photo image file(s) (or ICC profile(s) assumed as such by special photo retoucher 11) is or are set as working ICC profile(s), no special change is made to the photo image data thereof when such photo image file(s) is or are opened. In contradistinction hereto, if working ICC profile(s) is or are set which is or are different from ICC profile(s) previously embedded in such photo image file(s) (or assumed as such), perceptual color matching may be carried out on such photo image data based on such embedded ICC profile(s) and working ICC profile(s) when such photo image file(s) is or are opened. This color matching permits such photo image data to be adjusted such that color(s) most closely approximating color(s) represented in the color space defined by the previous ICC profile is or are representable in the working color space.

Furthermore, special photo retoucher 11 carries out processing for display of such photo image(s) at display monitor(s). More specifically, as indicated at step 105, special photo retoucher 11 converts such photo image data to image data belonging to monitor color space(s) defined by monitor ICC profile(s) previously prepared and made available at client system 5. At time or times of such conversion, special photo retoucher 11 carries out perceptual color matching for such photo image data making use of the foregoing working ICC profile(s) and the foregoing monitor ICC profile(s) for such photo image data. This permits such photo image data to be adjusted so that color(s) displayed on monitor(s) will be as close as possible to color(s) present in working color space(s). Furthermore, as indicated at step 106, special photo retoucher 11 displays, on monitor(s) (more specifically, at image display area 118 within window 110 shown in FIG. 5), monitor color space photo image data produced by such conversion.

Thereafter, as indicated at step 104, special photo retoucher 11 carries out various enhancements on such photo image(s) as requested by user(s) in TRIM, RETOUCH, COLOR/TONE, and/or EFFECT modes. With every enhancement which is carried out thereon, special photo retoucher 11 performs the foregoing steps 105 and 106 on the post-enhancement photo image(s), displaying such post-enhancement photo image(s) on monitor(s).

Lastly in EXPORT mode, as indicated at step 107, special photo retoucher 11 saves file(s) containing photo image(s) already incorporating various enhancements to user-designated photo folder(s) 12, at which time working ICC profile(s) for such photo image(s) is or are embedded in and saved with such photo image file(s).

As already described with reference to FIG. 3, saved photo image file(s) and working ICC profile(s) embedded therein are thereafter sent to print server machine 2 following termination of print layout editing and are converted to print image data by print server(s) 34 at print server machine 2. At such time or times, as indicated at step 108 in FIG. 7, print server(s) 34 carries or carry out perceptual color matching on such photo image data using working ICC profile(s) embedded in photo image file(s) and printer ICC profile(s) corresponding to the output printer and output media combination. This permits respective such photo image data to be adjusted, this then being incorporated in print image data, so as to produce color(s) when printed out that will be as close as possible to color(s) present in working color space(s) of such photo image(s).

A series of color matching processing operations such as has been described above permits results such as the following to be obtained.

In the event that ICC profile(s) embedded in photo image(s) by digital camera(s) 6 is or are caused to be set as working ICC profile(s) at the foregoing BROWSE mode, this will result in printed output being obtained which has color(s) satisfactorily approximating color(s) present in subject(s) photographed with digital camera(s) 6. As this is in fact the basic default setting (corresponding to the setting(s) shown by way of example at field 131 and/or field 132 in FIG. 6), user(s) is or are able to automatically obtain the foregoing result even where no particular setting has been entered for ICC profile(s).

On the other hand, in the event that monitor ICC profile(s)—and/or ICC profile(s) like “sRGB” which is or are extremely close thereto—is or are caused to be set as working ICC profile(s), this will result in a printed output being obtained which has color(s) satisfactorily approximating color(s) as displayed on monitor(s). As this is in fact the default setting in the event that there is no previously existing ICC profile(s) (corresponding to the setting(s) shown by way of example at field 133 in FIG. 6), user(s) is or are able to automatically obtain the foregoing result even where no particular setting has been entered for ICC profile(s).

Repeated reference is now made to retoucher main window 110 of FIG. 5.

Upon pressing TRIM button 112 and entering TRIM mode, selected photo image(s) is or are displayed at image display area 118. By dragging cursor(s) over photo image(s) at image display area 118, user(s) may cause rectangular selection locus or loci of dimensions as defined by drag start and end points to be set on photo image(s), and may crop away region(s) outside such selection locus or loci so as to extract only region(s) inside such selection locus or loci. If desired aspect ratio(s) is or are previously chosen at control area 119, then no matter how a user might perform the foregoing drag operation the aspect ratio(s) of the rectangular selection locus or loci set thereby may be automatically controlled so as to have the foregoing chosen aspect ratio(s). Furthermore, control area 119 includes button(s) causing selection locus or loci to be rotated to the right and/or rotated to the left in one-degree increments, pressing which permits selection locus or loci to be rotated to the left and/or rotated to the right in one-degree increments. This permits facilitation of cropping operations.

Next, if RETOUCH button 113 is pressed and RETOUCH mode is entered, photo image(s) as cropped in TRIM mode may be displayed in image display area 118. Displayed at control area 119 there are, within the same screen(s), a number of selectable choices of prescribed retouching tools frequently used at photo studios; slider bar(s) for adjusting intensity or intensities of enhancement effect(s); list(s) of plurality or pluralities of brushes of different size, degree of blurring, shape, and angle; and a plurality of slider bars for adjusting size, degree of blurring, shape, and angle of respective brush(es). After choosing, at control area 119, desired tools(s), desired enhancement effect intensity or intensities, and brush(es) having desired size(s), degree(s) of blurring, shape(s), and angle(s), user(s) may place cursor(s) at desired location(s) in photo image(s) within image display area 118 and carry out desired enhancement(s) at such location(s). At such time or times, because cursor(s) is or are displayed on photo image(s) within image display area 118 as graphic(s) (e.g., a closed graphic accurately indicating the outline of a brush) having the same size, shape, and angle as brush(es) (i.e., region(s) at which enhancement(s) will be applied) used by user(s), user(s) can accurately ascertain location(s) in photo image(s) at which enhancement(s) will be applied.

Next, if COLOR/TONE button 114 is pressed and COLOR/TONE mode is entered, photo image(s) with enhancement(s) as applied in RETOUCH mode may be displayed in image display area 118. In this mode, photo image color may be adjusted. This mode comprises the three submodes EASY, VARIATION, and MANUAL. Desired mode(s) may be selected from among these three at control area 119.

Upon selection of the EASY submode, a plurality of selectable choices of preprepared color adjustment filters are displayed in control area 119. Such selectable choices might, for example, include STANDARD COLOR CORRECTION, PORTRAIT PHOTO COLOR CORRECTION, MAKE INTO MONOCHROME PHOTO, LIGHTEN, MAKE HEAVIER, SHARPEN, SOFTEN, and/or the like. By choosing desired selectable choice(s), it is possible to cause prescribed color adjustment filter(s) corresponding thereto to be applied to the entirety or entireties of photo image(s). It is also possible to manually alter parameter(s) of respective filter(s).

Upon selection of the VARIATION submode, parameter setting table(s) for allowing user(s) to freely set values of a prescribed plurality of major parameters (e.g., brightness, contrast, gray balance, saturation, sharpness, and/or the like) from among a variety of parameters for color adjustment filter(s) is or are displayed in control area 119. A desired parameter may be selected from among the foregoing plurality of parameters at such parameter setting table(s). Furthermore, displayed horizontally and vertically in arrayed fashion at image display area 118 there may be, within the same screen(s), a plurality of (e.g., 3, 9, 25, etc.) photo images which respectively represent results of application in trial fashion of a plurality of (e.g., 3, 9, 25, etc.) color adjustment filters having different parameter values to the same photo image(s). The photo image(s) centrally located thereamong represents or represent the result of application in trial fashion of color adjustment filter(s) having parameter value(s) as currently set at control area 119. Furthermore, respectively arrayed in order to either side of central photo image(s) are results of application in trial fashion of color adjustment filter(s) for which parameter(s) selected by user(s) at the foregoing parameter setting table(s) is or are decreased in step(s) of prescribed value(s) from currently set parameter value(s), and conversely, results of application in trial fashion of color adjustment filter(s) for which parameter(s) selected by user(s) at the foregoing parameter setting table(s) is or are increased in step(s) of prescribed value(s) from currently set parameter value(s). Accordingly, user(s) can compare such plurality of photo images differing with respect to color(s), and can easily determine which color(s) is or are most preferred. Upon selection by user(s) of photo image(s) having desired color(s), such selected photo image(s) may automatically be made to move to the center of image display area 118, and parameter value(s) for color adjustment filter(s) applied to such selected photo image(s) may be caused to be set at control area 119. Upon proceeding to other mode(s) and/or other submode(s), color adjustment filter(s) having particular parameter value(s) as set at control area 119 may be automatically applied to photo image(s).

Upon selection of the MANUAL submode, various tools and indicators for even more detailed setting of color adjustment filter parameters than at VARIATION submode are displayed at control area 119, use of which permits more detailed adjustment of color to be carried out.

Upon termination of color adjustment in the foregoing COLOR/TONE mode, by next pressing EFFECT button 115, EFFECT mode is entered, wherein special effects filter(s) may be used to apply desired special effect(s) to entire photo image(s).

As described above, sequential execution of TRIM, RETOUCH, COLOR/TONE, and/or EFFECT modes makes it possible for all enhancements typically required at photo studios to be applied without omission to photo image(s).

Now, in the event that during the course of TRIM through EFFECT modes a user decides he or she wants to make use of ordinary photo retoucher 15, all the user need do is press PHOTO APPLICATION button 123 at retoucher main window 110 in FIG. 5. Upon so doing, special photo retoucher 11 saves, to photo folder(s) 12, file(s) containing photo image(s) incorporating results of enhancement(s) performed up to that point in time, and launches ordinary photo retoucher 15 using path(s) of such saved photo image file(s) as parameter(s) for launch command(s), with special photo retoucher 11 itself furthermore becoming inactive. As a result, because ordinary photo retoucher 15 is launched, opening that or those saved photo image file(s), user(s) may use ordinary photo retoucher 15 to carry out subsequent retouching operations. Upon termination of operations with ordinary photo retoucher 15, saving of photo image(s) incorporating the results of such operations to the same photo folder(s) 12 under the same file name(s), and termination of ordinary photo retoucher 15, special photo retoucher 11 automatically becomes active and reopens such photo image file(s) after first causing ICC profile(s) to again be set for such photo image file(s). As a result, user(s) is or are able to again use special photo retoucher 11 to carry out subsequent operations.

Proceeding finally to EXPORT mode, when user(s) requests or request that photo image(s) be saved, special photo retoucher 11 saves, to photo folder(s) 12, file(s) containing such photo image(s), working ICC profile(s) set at BROWSE mode being embedded therein.

With the foregoing, retouching operations carried out on one photo image using special photo retoucher 11 are ended. Retouching operations may thereafter be continued, such operations being carried out on other photo image(s).

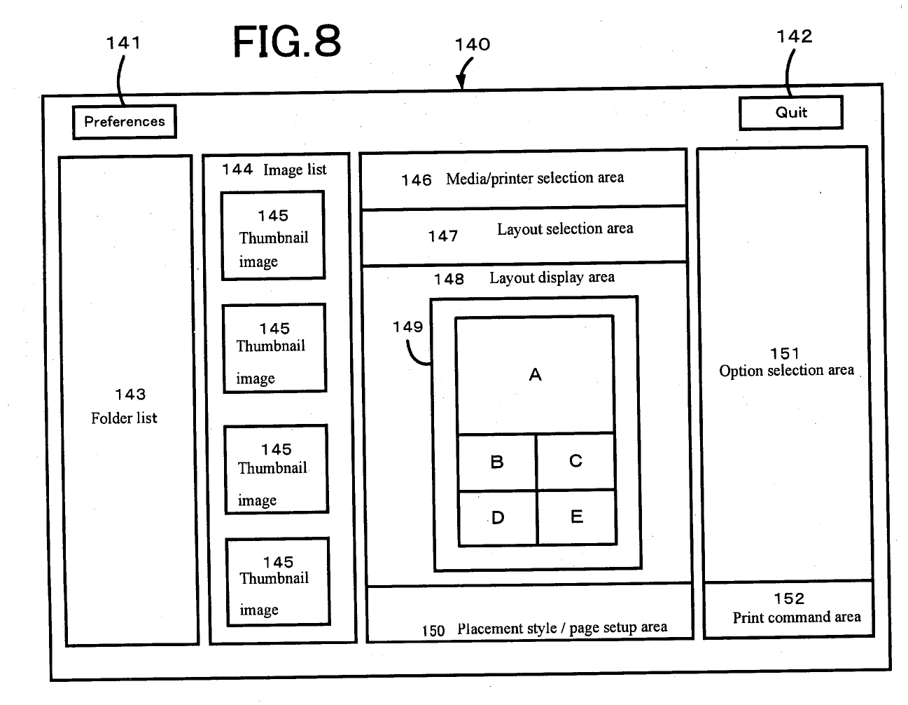

Repeated reference is now made to FIG. 3. If print layout editing is to be done, user(s) launch layout editor 13. Layout editor 13 displays graphical user interface(s) (hereinafter “layout editor main window”) 140 such as is shown at FIG. 8 at monitor(s) of client system 5.

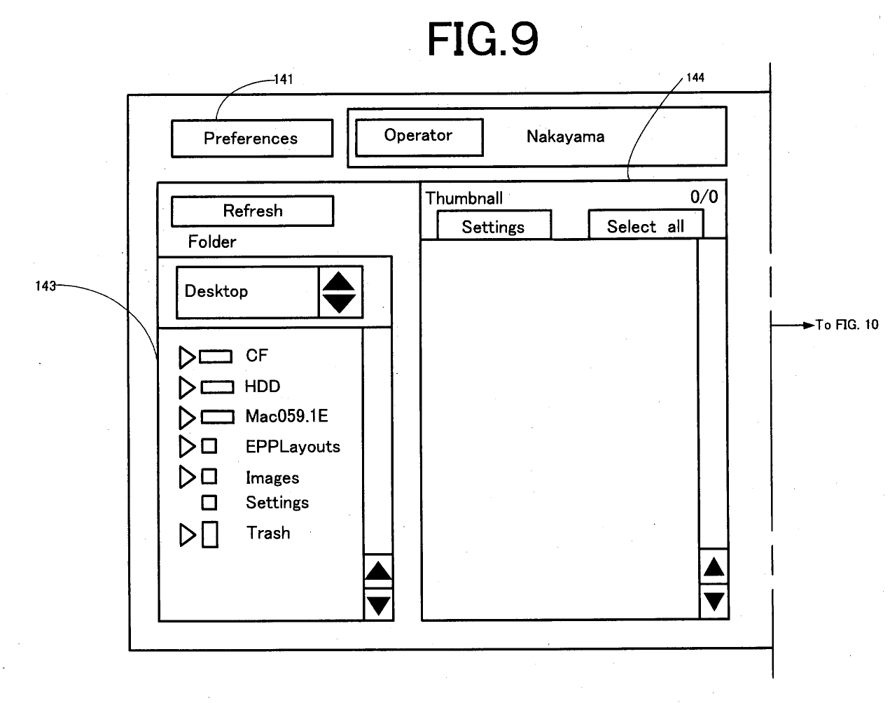

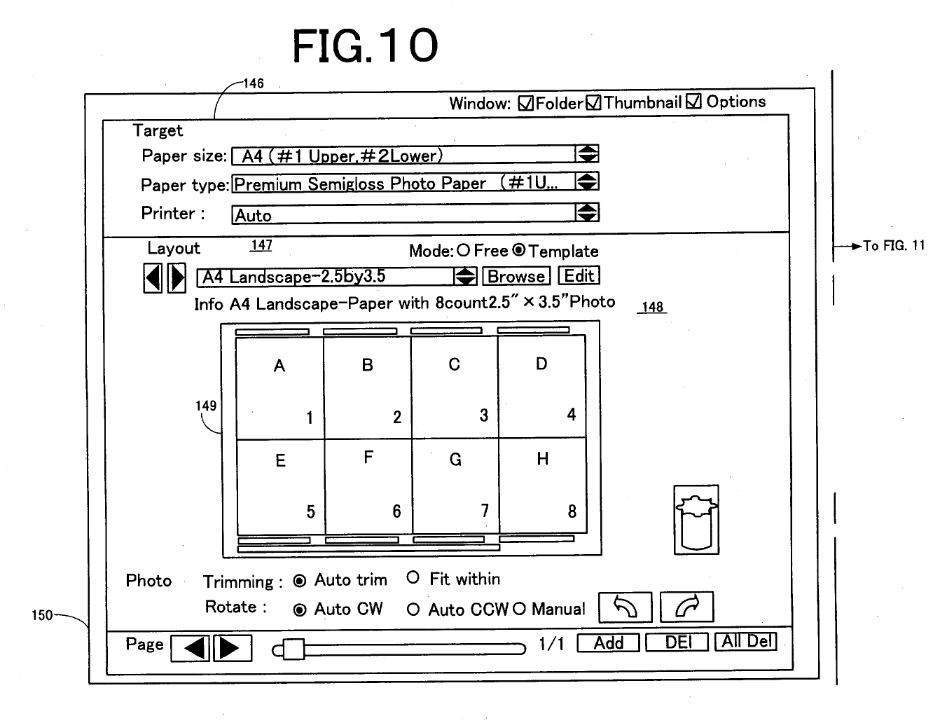

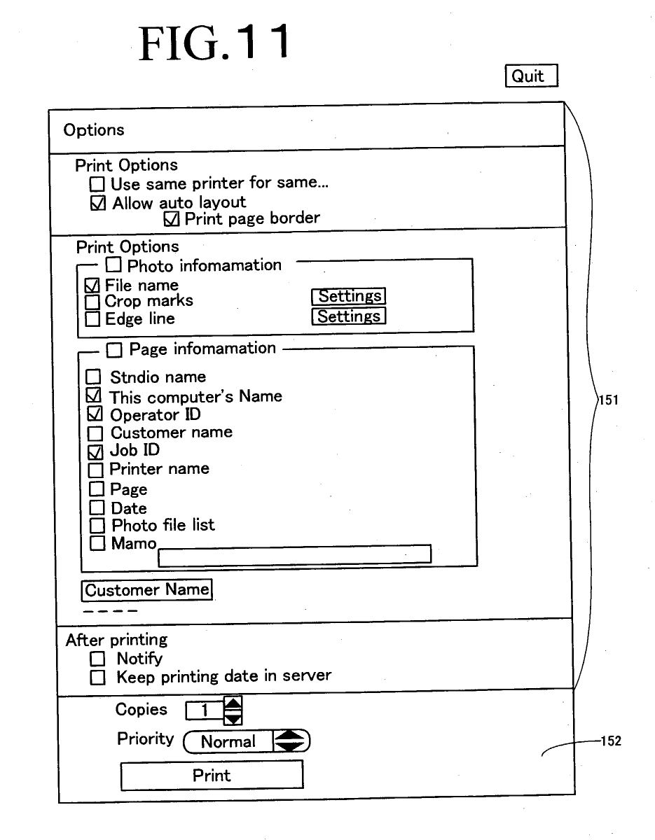

As shown at FIG. 8, layout editor main window 140 contains PREFERENCES button 141, folder list 143, image list 144, media/printer selection area 146, layout selection area 147, layout display area 148, placement style/page setup area 150, option selection area 151, print command area 152, and so forth. Note that FIGS. 9 through 11 show a specific example of the layout editor main window 140 which appears in FIG. 8. Elements in FIGS. 9 through 11 which are identical to those appearing in FIG. 8 have been given identical reference numerals.

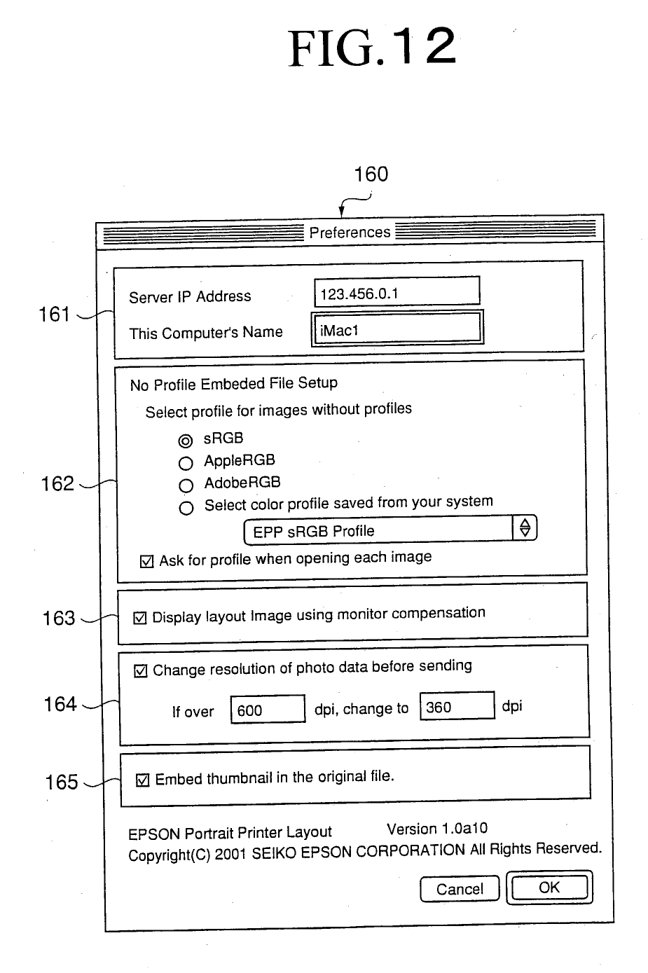

At FIG. 8, upon pressing PREFERENCES button 141, a PREFERENCES dialog box 160 such as is shown in FIG. 12 is displayed in popup fashion. At NO PROFILE EMBEDDED FILE SETUP field 162 of this PREFERENCES dialog box 160, it is possible—just as was the case at field 133 of the same name shown in FIG. 6—to set ICC profile(s) automatically assumed and used as if it or they had been embedded in photo image file(s) in which ICC profile(s) is or are not yet embedded (e.g., the default setting being “sRGB”—corresponding to a typical monitor color space).

At FIG. 8, list(s) of all folders belonging to client system 5 is or are displayed at folder list 143 within layout editor main window 140. Upon selection by user(s) of desired folder(s) therefrom, thumbnail images 145, 145, . . . for all photo image files saved in such selected folder(s) are displayed at image list 144.

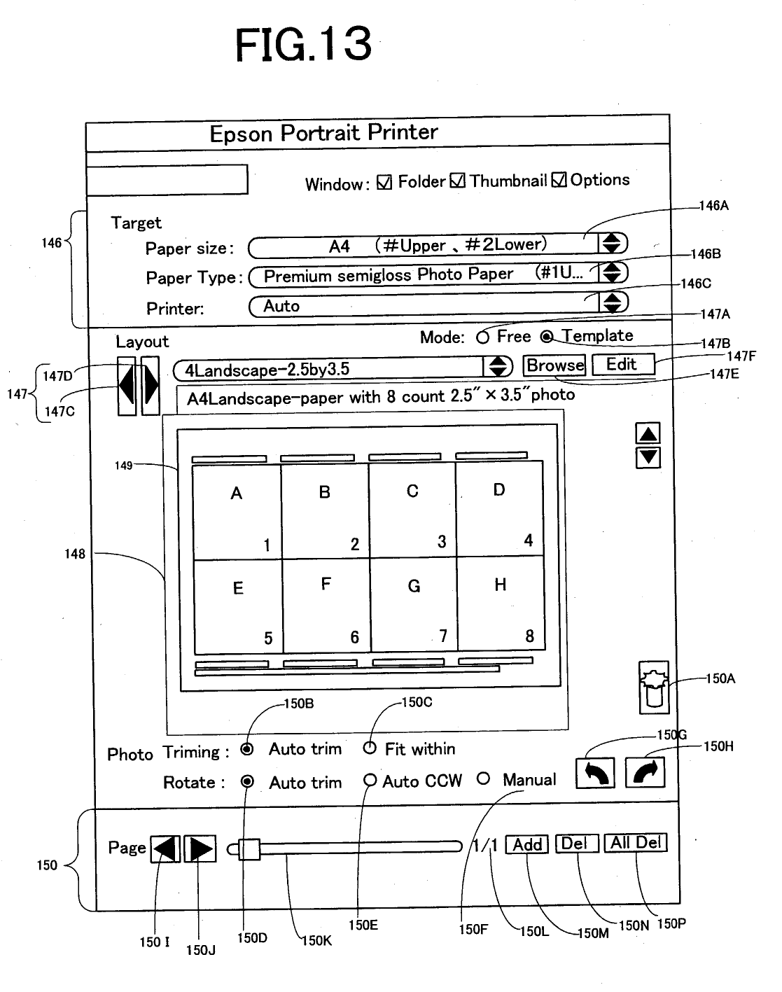

Furthermore, output printer(s) as well as type(s) and size(s) of print media to be used during printing may be specified at media/printer selection area 146. That is, upon clicking on the paper size popup list indicated at reference numeral 146A in FIG. 13, the size A4 may for example be displayed in popup fashion as paper size(s) to be actually used during printing among media (paper) size(s) capable of being used at the foregoing printers 3A, 3B which is or are listed therein. Furthermore, upon clicking on the paper type popup list indicated at reference numeral 146B in FIG. 13, premium semigloss photo paper may for example be displayed in popup fashion as paper type(s) to be actually used during printing among paper type(s) capable of being used at the foregoing printers 3A, 3B which is or are listed therein. In other words, paper type(s) of printers 3A, 3B having paper of size(s) as large as or larger than that or those selected at paper size popup list 146A will be valid.

In the event that the foregoing selected paper type(s) differs or differ from paper type(s) currently selected at printer(s) (3A, 3B), that selection will still be valid but actual printing operations will have to wait until printing paper cassette(s) have been changed to that or those of the foregoing selected paper type(s). Furthermore, upon clicking on the printer popup list indicated at reference numeral 146C in FIG. 13, printer 3A (and/or 3B) may for example be displayed in popup fashion as output printer(s) (printer(s) to be actually used) among list(s), downloaded from the foregoing print server machine 2, of printer(s) which is or are capable of being used at the foregoing print server machine 2. Note however that the foregoing selection will only be valid if the printer(s) selected has or have paper of size(s) as large as or larger than that or those selected at paper size popup list 146A. Moreover, printer selection also includes, at the beginning of the foregoing list(s), the item AUTO, for leaving the decision up to the foregoing printer server machine 2.

Because any changes made during free mode after selection of printer(s) may alter the region(s) which can be safely printed, updating of layout region(s) may be carried out. Paper type(s), paper size(s), and/or printer information capable of being used at the foregoing printer server machine 2 is or are checked every so many seconds (e.g., every 5 seconds), and in the event of any change thereto, the respective corresponding list(s) is or are updated. The foregoing interval between successive checks may be changed. Furthermore, in specifying output printer(s), one of the plurality of printers 3A, 3B shown in FIG. 4 may be specified explicitly, or autoselect (the foregoing AUTO, whereby the system automatically selects the most suitable or convenient printer(s)) may be specified.

In the event that user(s) specifies or specify particular printer(s) as output printer(s), the system carries out printing of all pages in such job(s) and all sets of copies thereof using only the particular printer(s) specified. On the other hand, in the event that user(s) specifies or specify autoselect, the system automatically selects printer(s) to carry out printing of respective pages and respective sets of copies thereof in correspondence to conditions at printers 3A, 3B. Where autoselect has been specified, it therefore possible that printing of a single job will be distributed across different printers.

Furthermore, at layout selection area 147, list(s) of multiple varieties of layout templates saved in template library folder 32 at print server machine 2 shown in FIG. 3 may be displayed in for example pulldown menu, dialog box, or other such fashion, permitting desired template(s) to be selected therefrom. Selected template(s) is or are acquired by layout editor 13 from template library folder 32 of print server machine 2 shown in FIG. 3 by way of file transfer server 31, and is or are displayed in layout display area 148 at layout editor main window 140 shown in FIG. 8.

At layout selection area 147, there is in FIG. 13 a free mode radio button indicated by reference numeral 147A and a template mode radio button indicated by reference numeral 147B, these serving as mode selection buttons capable of causing either free mode or template mode to be set in alternative fashion. In the present embodiment, template mode is set as the default mode.

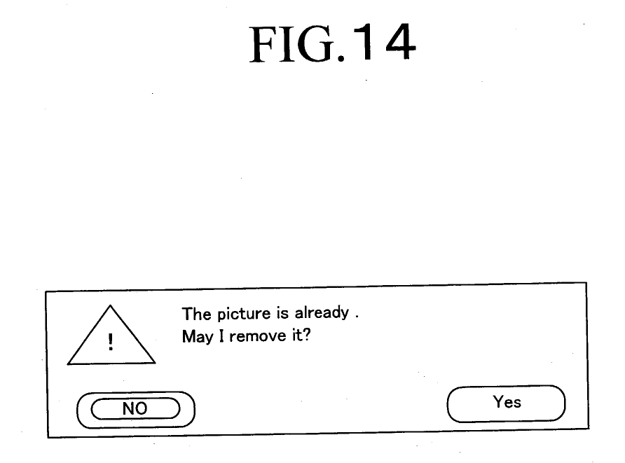

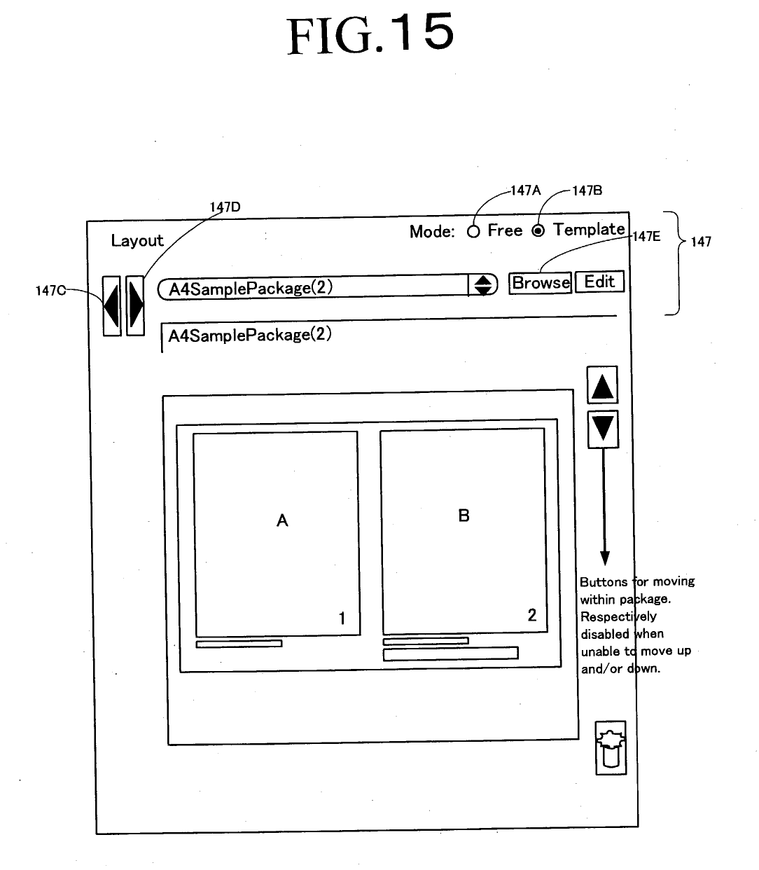

When switching modes from template mode to free mode as a result of clicking on free mode radio button 147A, and/or when switching modes from free mode to template mode as a result of clicking on template mode radio button 147B, a message asking whether it is alright to discard current (pre-switching) layout content such as is shown in FIG. 14 may be displayed at layout display area 148. At FIG. 14, if the NO button is clicked the user is returned to the pre-switching mode, but if the YES button is clicked the current (pre-switching) layout content is discarded. Upon selecting template mode, a screen such as is shown in FIG. 15 is displayed, permitting selection of template(s) and/or package(s), and permitting assignment of basically a different template for each page, but only where paper size(s) is or are identical.

In template mode, apportionment of image(s) is ordinarily carried out with template(s) being set for each individual page. Group(s) are closed for each page. Package(s) may be such that a plurality of templates are treated as a single pack (multiple pages), and group(s) within package(s) may be such that all are treated as if it or they are the same group(s), the same image(s) being assignable thereto. FIG. 15 shows a screen which is presented when package(s) is or are employed. List(s) (referred to as “dropdown list(s)”) of name(s) of template(s) corresponding to print media size(s) specified at the foregoing media/printer selection area 146 may be displayed at the screen presented when package(s) is or are employed which is shown in FIG. 15. Layout editor 13 obtains such template information (i.e., dropdown list(s)) from print server machine 2 shown in FIGS. 2 through 4. Upon selection of only a single desired template name from such a list, description(s) of that template name may be displayed below that list and selected template(s) may be displayed at layout display area 148.

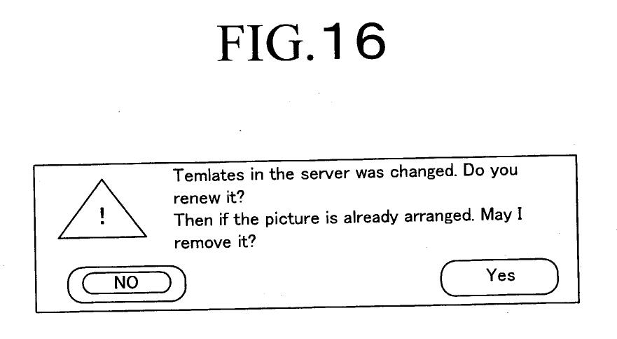

Upon making any change(s) to template(s) for selection while image(s) is or are displayed at layout display area 148, a message similar to that shown in FIG. 14 may be displayed and operations similar to the foregoing may be carried out, permitting template(s) to be returned to their pre-change(s) state(s) and/or current layout content to be discarded. Print server machine 2, shown in FIGS. 2 through 4, checks, e.g., every 15 seconds, to see whether change(s) has or have been made to template information, and in the event of any change(s) thereto, updates the foregoing list(s). The foregoing interval between successive checks may, for example, be set such that checking occurs at a frequency of once for every 3 times that printer information is checked. When change(s) is or are made to template information at print server machine 2, print server machine 2 displays at layout display area 148 of layout editor 13 the message shown in FIG. 16, soliciting update of template information at layout editor 13.

At FIG. 16, if the YES button is clicked, layout editor 13 obtains new template list(s) from print server machine 2 and updates display at layout display area 148 based on the template list(s) which it obtained. Any image(s) undergoing layout operations at such time(s) is or are discarded. Conversely, if the NO button is clicked, any in-progress print server machine 2 template checking activity or activities is or are stopped.

Furthermore, included at layout selection area 147 in FIG. 13 there are also a “←” button indicated at reference numeral 147C and a “→” button indicated at reference numeral 147D.←button 147C is clicked when selecting previous items(s) relative to currently selected item(s), and→button 147D is clicked when selecting next item(s) relative to currently selected item(s), causing dropdown list(s), template description(s), and/or layout region(s) to be updated. Clicking←button 147C when the currently selected item(s) is or are the first item(s) permits the last item(s) to be selected in loop fashion, and clicking→button 147D when the currently selected item(s) is or are the last item(s) permits the first item(s) to be selected in loop fashion. In the event that change(s) is or are made to template(s) for selection while image(s) is or are arranged at layout display area 148, a message similar to that which is shown in FIG. 14 may be displayed and operations similar to the foregoing may be carried out, permitting template(s) to be returned to their pre-change(s) state(s) and/or current layout content to be discarded.

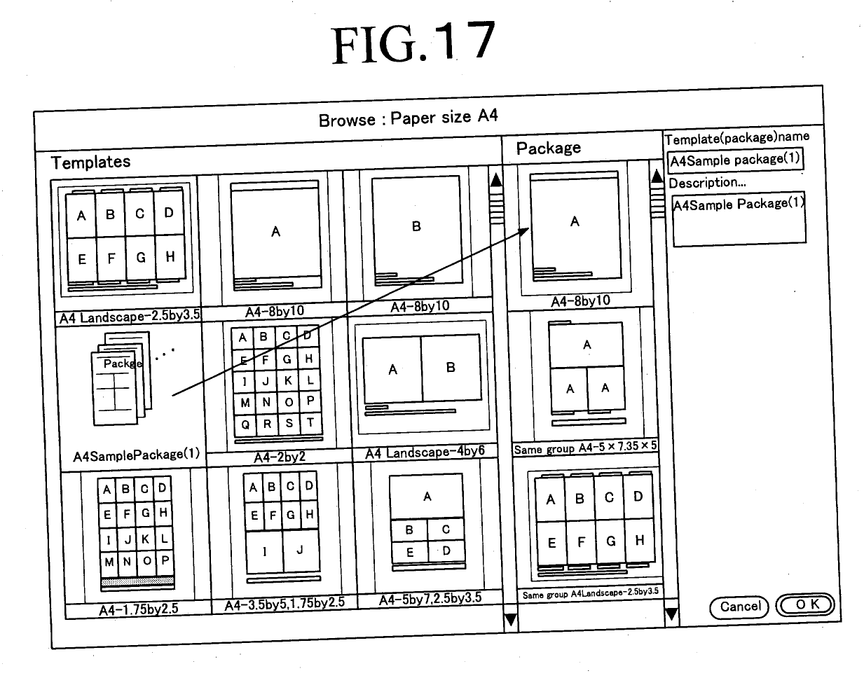

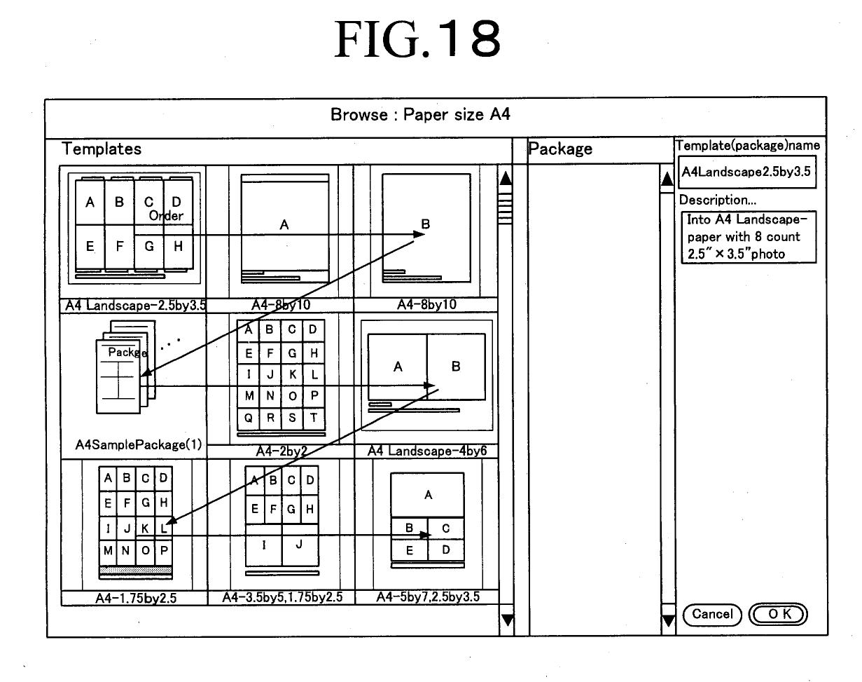

Furthermore, included at layout selection area 147 in FIG. 13 there is also a browse button indicated at reference numeral 147E. Upon clicking browse button 147E, a dialog box such as that shown in FIG. 17 may be displayed, permitting selection of desired template(s). Clicking browse button 147E causes currently selected paper (media) size(s) to be displayed in window title(s). Furthermore, as shown in FIG. 17, respective template(s) is or are displayed in template list(s). Currently selected template(s) may be selected by default at the dialog box which is displayed. Special picture(s) is or are displayed at package(s), selection of package(s) causing template(s) within package(s) to be displayed in list(s) at the right as shown in FIG. 17. Clicking on template(s) causes dropdown list(s), template description(s), and/or layout region(s) to be updated pursuant to template(s) selected at template list(s). Furthermore, template(s) display frame(s) of color(s) as set by the template editor. Moreover, template list(s) permit reordering through dragging of layout thumbnail(s). Such order(s) may be reflected at package dropdown list(s) and/or template(s) at main screen(s). Clicking the OK button at FIG. 18 confirms template selection and template reordering. Identical operations may also be carried out upon double-clicking specific template(s). On the other hand, clicking the CANCEL button at FIG. 18 causes template selection and reordering to be ignored and the user to be returned to the main screen(s).

Furthermore, included at layout selection area 147 in FIG. 13 there is also a template editor launch button indicated at reference numeral 147F. Clicking template editor launch button 147F causes launching of template creation tool(s). At time(s) when template creation tool(s) is or are launched, current template file name(s), operator ID(s), and/or password(s) (for user identification and editing) may be passed to template creation tool(s). At time(s) when template creation tool(s) terminates or terminate, by obtaining template file name(s) from template creation tool(s), template(s) which was or were the last to be saved may be taken to be current template(s). In the event that image(s) is or are arranged at layout display area 148, a message similar to that shown in FIG. 14 may be displayed in order to ask user(s) whether it is alright to discard current layout content. If it is OK (if the YES button is clicked) the current layout content is discarded, but if the user wants to cancel the operation (if the NO button is clicked) the template editing tool(s) (template creation tool(s)) is or are not launched. Note that if the user does not have template editing privileges, template editor launch button 147F will be disabled.

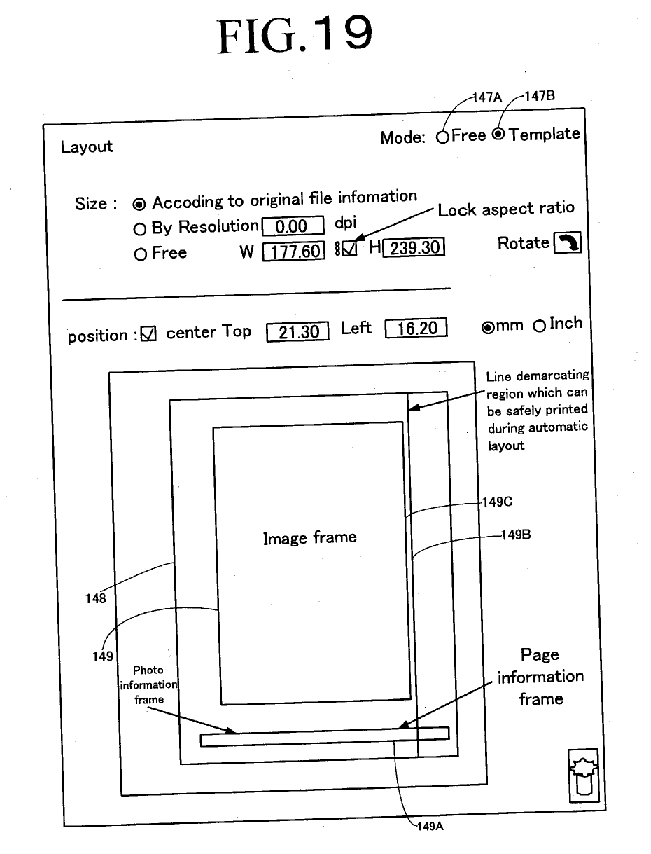

FIG. 19 shows layout selection area 147 and layout display area 148 as they appear after switching of modes from template mode to free mode as a result of clicking on free mode radio button 147A at layout selection area 147.

Upon switching to free mode as a result of clicking on free mode radio button 147A, screen display may be as shown in FIG. 19, permitting free adjustment of image size. In such a case, image information position(s) and size(s), and page information frame 149A position(s) and size(s), do not change. Before any image(s) is or are dragged and dropped, image frame 149C, extending right up to the limit of the region(s) which can be safely printed, is displayed in the central region. Group display is not carried out at such time(s). Image frame 149C may be moved within the region(s) which can be safely printed, top and/or left coordinate(s) of said image frame 149C being displayed at POSITION TOP and/or LEFT in FIG. 19. Furthermore, value(s) set at ACCORDING TO ORIGINAL FILE INFORMATION, RESOLUTION, and/or SIZE apply when image(s) is or are dragged and dropped. In the event that value(s) previously entered as setting(s) at ACCORDING TO ORIGINAL FILE INFORMATION, RESOLUTION, and/or SIZE are too large, said entered value(s) may be set to the maximum value(s) capable of being used. Paging in this free mode is such that there may be one image frame per page. Moreover, reference numeral 149B indicates line(s) demarcating region(s) which can be safely printed during automatic layout.

Functions respectively possessed by the ACCORDING TO ORIGINAL FILE INFORMATION radio button, BY RESOLUTION radio button, SIZE, CENTER check box, TOP edit box, LEFT edit box, ROTATE button (image frame rotation button), MM radio button, and INCH radio button will now be described.

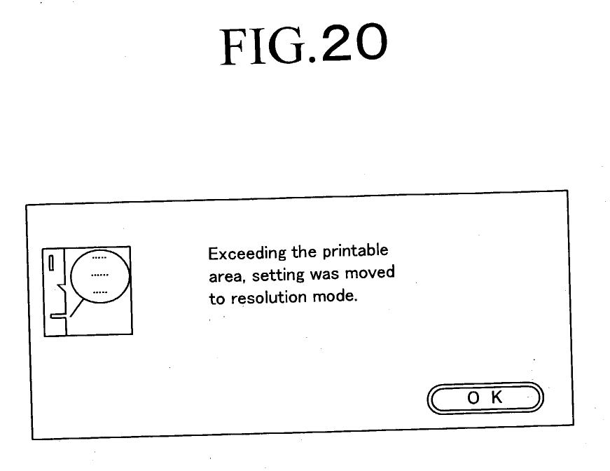

By clicking on the ACCORDING TO ORIGINAL FILE INFORMATION radio button, it is possible to cause image size(s) to be determined using resolution information included with image(s). Furthermore, when image(s) is or are dragged and dropped, layout thereof is carried out such that long edge(s) of image frame(s) is or are aligned with long edge(s) of image(s). Whereas the ACCORDING TO ORIGINAL FILE INFORMATION mode is selected by default, if an image that has been dragged and dropped does not contain resolution information a message such as that shown in FIG. 20 might be displayed and BY RESOLUTION might be selected. Also, if image frame(s) extends or extend beyond the foregoing region(s) which can be safely printed, a message such as that shown in FIG. 20 might be displayed, following which BY RESOLUTION might be selected and maximum value(s) permitting image frame(s) to fit within region(s) which can be safely printed might be set.

Image resolution(s) may be specified by clicking on the BY RESOLUTION radio button. When image(s) is or are dragged and dropped, layout thereof is carried out such that long edge(s) of image frame(s) is or are aligned with long edge(s) of image(s). Upon selecting the RESOLUTION item as a result of clicking on the BY RESOLUTION radio button, the W edit box and H edit box shown in FIG. 19 are enabled. In the event that invalid value(s) is or are entered at the W edit box and/or the H edit box, image frame(s) might be changed to maximum value(s) permitting it or them to fit within region(s) which can be safely printed. Likewise, in the event that value(s) extending beyond the foregoing region(s) which can be safely printed is or are entered at the W edit box and/or the H edit box, image frame(s) might be changed to maximum value(s) permitting it or them to fit within region(s) which can be safely printed.

Image frame height(s) and width(s) may be specified by selecting the SIZE item. It is also possible to alter size(s) through mouse operation(s) by dragging on edge(s) of image frame(s). Selecting the SIZE item causes the W edit box, H edit box, and lock aspect ratio box shown in FIG. 19 to be enabled. Furthermore, image frame height values and width values may also be specified in 1 mm units or in 0.1 inch units. In the event that lock aspect ratio is checked (ON), image frame height value and width value will be changed by identical ratio(s) when adjustment(s) is or are made to that height value and/or width value. Where there is or are image(s) which has or have been subjected to layout as described above, change(s) in height value(s) and/or width value(s) will cause change(s) in BY RESOLUTION value(s).

The CENTER check box may be used in any of the modes ACCORDING TO ORIGINAL FILE INFORMATION, BY RESOLUTION, and/or FREE. By checking the CENTER check box, the image frame indicated at reference numeral 149C in FIG. 19 can be made to move to the center of the region(s) which can be safely printed. So long as the CENTER check box is checked, image frame 149C will continue to be arranged at the center of the region(s) which can be safely printed despite any change(s) which may be made to the size(s) of said image frame 149C.

As was the case for the CENTER check box described above, the TOP edit box and LEFT edit box may be used in any of the modes ACCORDING TO ORIGINAL FILE INFORMATION, BY RESOLUTION, and/or FREE, these edit boxes being used to specify top and/or left coordinate(s) of the image frame. The image frame being capable of being moved by dragging thereon with a mouse, the TOP edit box and LEFT edit box are such that value(s) within these edit boxes change during movement of the image frame. Moreover, said image frame may be moved by clicking on said image frame and using the up-, down-, left-, and/or right-arrow key(s), the value(s) within the edit boxes (TOP edit box and LEFT edit box) changing during movement of the image frame. Furthermore, while moving the image frame using the mouse, by pressing the SHIFT key and dragging it is possible to cause the image frame to move in a straight line vertically, horizontally, or diagonally from a location at which the mouse is clicked.

The ROTATE button may also be used in any of the modes ACCORDING TO ORIGINAL FILE INFORMATION, BY RESOLUTION, and/or FREE, this button being used to rotate the image frame by 90°. Note that rotation of the laid out image(s) itself or themselves is accomplished not by using the ROTATE button but by clicking on PHOTOROTATE button(s) (the rotate right button and/or the rotate left button) within layout display area 148. Moreover, if rotation of the image frame would cause the image frame to extend past the region(s) which can be safely printed shown in FIG. 19, the image frame will not be rotated despite the fact that the ROTATE button is clicked.

The MM radio button is clicked in order to change the units displayed at the W edit box, H edit box, TOP edit box, and LEFT edit box from inches to millimeters. Likewise, the INCH radio button is clicked in order to change the units displayed at the W edit box, H edit box, TOP edit box, and LEFT edit box from millimeters to inches.

Layout template(s) 149 displayed at layout display area 148 occupy space(s) of the same size(s) as print media size(s) selected at media/printer selection area 146, and arrayed therein pursuant to predefined layout(s) there may be one or a plurality of photo frame(s) A through E of standard size(s) standardly used for photo prints.

If desired thumbnail image(s) from image list 144 is or are dragged and dropped by user(s) onto desired photo frame(s) within template(s) 149 at layout display area 148, layout editor 13 will open file(s) containing photo image(s) corresponding to such thumbnail image(s), displaying such photo image(s) such that it or they are placed within such photo frame(s). When placing photo image(s) in photo frame(s), layout editor 13 carries out any required adjustment with respect to photo image dimensions and/or direction, such as changing photo image size and/or direction, cropping portion(s) extending beyond photo frame(s), or adding margin(s) to portion(s) falling short of photo frame size(s), in accordance with placement style(s) set at placement style/page setup area 150, described below. When user(s) have dragged and dropped onto desired photo frame(s) within template(s) 149 all photo images which the user(s) wants or want to print on the same media, print layout for that or those print page(s) is completed.

When placing respective photo image(s) in respective photo frame(s) within template(s) 149 as described above, layout editor 13 automatically (always, unless otherwise requested by the user) causes working ICC profile(s) to be set for such photo image(s) as described below. To wit, if ICC profile(s) has or have previously been embedded in such photo image file(s), such previous ICC profile(s) is or are caused to be set as working ICC profile(s). If, on the other hand, such photo image file(s) does or do not yet have ICC profile(s) embedded therein, ICC profile(s) set at NO PROFILE EMBEDDED FILE SETUP field 162 in dialog box 160 shown in FIG. 12, described above, is or are treated as if it or they had previously been embedded in such photo image file(s), and such ICC profile(s) treated as if it or they had been embedded therein is or are caused to be set as working ICC profile(s).

At placement style/page setup area 150, style(s) may be set for placement of photo image(s) within respective photo frame(s) at template(s) 149. Setup items include setting(s) pertaining to rotation and setting(s) pertaining to trimming to be carried out if aspect ratio(s) of photo frame(s) and photo image(s) do not match. With respect to trimming styles, either AUTOTRIM (i.e., a style such that photo image(s) is or are made to occupy photo frame(s) without production of margin(s) therebetween by automatically trimming excess regions at either end in the long direction of photo image(s) so as to cause dimension(s) in the short direction of photo image(s) to match dimension(s) in same direction of photo frame(s)) or FIT WITHIN (i.e., a style such that photo image(s) is or are made to occupy photo frame(s) without trimming of photo image(s) by automatically adding margins at either side in the short direction thereof so as to cause dimension(s) in the long direction of photo image(s) to match dimension(s) in same direction of photo frame(s)) may be selected. With respect to rotation styles, either AUTOCLOCKWISE and AUTOCOUNTERCLOCKWISE (i.e., styles such that photo image(s) is or are automatically rotated 90 degrees in respectively clockwise and counterclockwise directions so as to cause the long direction of photo image(s) and the long direction of photo frame(s) to be in the same direction) or MANUAL (i.e., a style permitting 90-degree manual rotation by user(s) in desired direction(s)) may be selected. Because layout editor 13 automatically causes photo image(s) dropped in respective photo frame(s) to be placed in such photo frame(s) using placement style(s) as set here, photo image size adjustment operations are very much facilitated.

At placement style/page setup area 150, where page(s) currently being edited using template(s) 149 will fall within print job(s); i.e., which page(s) therein it or they will correspond to, may also be set. When editing print layout(s) of print job(s) comprising a plurality of pages, one need only add page(s) at this placement style/page setup area 150, and, for each respective page, select template(s) as described above, dragging and dropping desired photo image(s) onto respective photo frame(s) therein. Layout editing is thus very much facilitated.

Placement style/page setup area 150 will now be described in more specific terms with reference to FIG. 13.

Settable at placement style/page setup area 150 in a manner such as is shown by way of example in FIG. 13 there may be a trash can 150A, PHOTO items comprising TRIMMING items and/or ROTATE items, and/or PAGE items. Settable at the TRIMMING items there may be AUTOTRIM (automatic trimming) radio button 150B and/or FIT WITHIN radio button 150C, and settable at the ROTATE items there may be AUTOCW (automatically rotate clockwise) radio button 150D, AUTOCCW (automatically rotate counterclockwise) radio button 150E, MANUAL radio button 150F, rotate left button 150G, and/or rotate right button 150H. Furthermore, settable at the PAGE items there may be go to previous page button (“←”) 150I, go to next page button (“→”) 150J, go to page slider bar 150K, number of pages indicator 150L, ADD button 150M, DEL button 150N, and/or ALL DEL button 150P.

Since trash can 150A is used when deleting previously laid out image(s) from image frame(s), image(s) which has or have already undergone layout may be deleted from image frame(s) by performing a standard OS key sequence (at client machine(s) 5A, 5B), by dragging and dropping onto trash can 150A representing a dedicated trash can, or by clicking trash can 150A. Note however that once an image is discarded using trash can 150A, it cannot be restored.

The PHOTO items are for carrying out settings in connection with trimming and rotation of image(s) subject to layout and of dragged and dropped image(s), and by selecting previously laid out image frame(s) at layout region(s) (layout template(s) 149 shown in FIG. 8) it is possible to cause settings in connection with trimming and rotation of said image(s) to be displayed. Furthermore, by clicking on a region other than an image frame for which image(s) has or have already been laid out, it is possible to select page frame(s) and cause trimming and rotation settings which are applied by default during dragging and dropping to be displayed

At the TRIMMING items, AUTOTRIM radio button 150B, when clicked, permits settings to be carried out such that image(s) is or are placed in center(s) of layout template(s) 149 shown in FIG. 8 so that either the top and bottom or the left and right sides of image(s) are made to just fit within image frame(s) without production of margin(s) and with no change to image aspect ratio(s). Note that since portion(s) of image(s) which extend past image frame(s) are automatically trimmed away, it or they will not be printed.

FIT WITHIN radio button 150C, when clicked, permits settings to be carried out such that image(s) is or are placed in center(s) of layout template(s) 149 shown in FIG. 8 so that the entire image(s) fit within image frame(s) with no change to image aspect ratio(s). In so doing, margin(s) may be formed between the image frame and the top and bottom, or left and right, sides of an image.

At the ROTATE items, AUTOCW radio button 150D, when clicked, permits settings to be carried out such that image(s) is or are automatically rotated 90° clockwise so as to cause the long direction(s) of image(s) to be oriented in the same direction(s) as the long direction(s) of image frame(s). An image will not be rotated if the long direction of the image and the long direction of the image frame are oriented in the same direction.

AUTOCCW radio button 150E, when clicked, permits settings to be carried out such that image(s) is or are automatically rotated 90° counterclockwise so as to cause the long direction(s) of image(s) to be oriented in the same direction(s) as the long direction(s) of image frame(s). An image will not be rotated if the long direction of the image and the long direction of the image frame are oriented in the same direction.

MANUAL radio button 150F is clicked in order to cause image(s) to be oriented as indicated.

Rotate left button 150G, when clicked, causes image(s) to be rotated 90° to the left, said image(s) being rotated 180° to the left relative to its or their currently displayed state when AUTOCW radio button 150D is selected. Furthermore, said image(s) will be rotated 90° to the left relative to its or their currently displayed state when MANUAL radio button 150F is selected.

Rotate right button 150H, when clicked, causes image(s) to be rotated 90° to the right, said image(s) being rotated 180° to the right relative to its or their currently displayed state when AUTOCCW radio button 150E is selected. Furthermore, said image(s) will be rotated 90° to the right relative to its or their currently displayed state when MANUAL radio button 150F is selected.

The PAGE items are for adding and/or deleting pages, and/or setting the page(s) to be displayed.

Go to previous page button 150I is clicked in order to cause a page immediately preceding a page currently displayed at layout template 149 to be displayed at layout template 149. Clicking on go to previous page button 150I when there is only a total of one page will result in a display of invalid, or a display of DISABLE when the page currently displayed at layout template 149 is the first page.

Go to next page button 150J is clicked in order to cause a page following a page currently displayed at layout template 149 to be displayed at layout template 149. Clicking on go to next page button 150J when there is only a total of one page will result in a display of invalid, or a display of DISABLE when the page currently displayed at layout template 149 is the last page.

By clicking on go to page slider bar 150K it is possible to select page(s) which is or are displayed at layout template 149. Clicking on go to page slider bar 150K causes the displayed page and the total number of pages (e.g., as in “⅓”) to be displayed at number of pages indicator 150L beside go to page slider bar 150K.

By clicking on ADD button 150M it is possible to cause page(s) to be added and/or to cause added page(s) to be displayed at layout template 149. Clicking ADD button 150M causes a new page to be added after a page which is currently displayed at layout template 149.

By clicking on DEL button 15ON it is possible to delete page(s) and/or package(s) which is or are currently being displayed at layout template 149. In the event that DEL button 15ON is clicked at a time when image(s) is or are laid out in page(s) being displayed at layout template 149, a message similar to that shown in FIG. 14 may be displayed in order to ask user(s) whether it is alright to discard current layout content. Furthermore, if it is OK (if the YES button is clicked), the current layout content would be deleted. Clicking on DEL button 15ON when there is only a total of one page will result in a display advising that the operation is invalid.

ALL DEL button 150P can be used at any time. In the event that ALL DEL button 150P is clicked at a time when image(s) is or are laid out in page(s), a message similar to that shown in FIG. 14 may be displayed in order to ask user(s) whether it is alright to discard that layout content. Furthermore, if it is OK (if the YES button is clicked), that layout content would be deleted. Note that at a time when the foregoing deletion is carried out the current template(s) and/or current package(s) will be initialized. In addition, following deletion, page default rotation mode(s) and trimming will be set for the current page.

At option selection area 151, optional items may be set with respect to PRINTER OPTIONS, PRINT OPTIONS, and AFTER PRINTING. With respect to PRINTER OPTIONS, when carrying out distributed printing such that the same job(s) is or are printed in distributed fashion across a plurality of printers (if autoselect is specified at media/printer selection area 146, because the system automatically assigns output printer(s) for respective pages and respective sets of copies of such job(s) in correspondence to conditions at printer(s) it is possible that distributed printing could occur), whether the same page(s) is or are to be printed at the same printer(s) and/or whether the same job(s) is or are to be printed at the same printer(s) (whether distributed printing is to be prohibited) may be set. If printing is carried out on the same printer(s), print quality will be the. same throughout all sets of copies thereof.

With respect to PRINTER OPTIONS, moreover, whether it is okay to use print media of the same type(s) but of larger size(s) for printing when paper of the specified size(s) is or are not loaded at specified printer(s) may be set. If OKAY is set here, whether paper frame(s) of size(s) corresponding to paper of the specified size(s) should be printed together therewith may furthermore be set. Where it has been set that it is OKAY to use paper of larger size(s) for printing, in order to eliminate uneconomical use of paper the system automatically controls print layout at respective page(s) of paper so as to cause respective page(s) of such job(s) to print at location(s) toward the edge(s) of such larger sized paper. If, for example, A4 size was specified for such job(s) but there is no A4 paper, printing instead being carried out on A3 paper which is twice the size thereof, the system would print page(s) of such job(s) in one of two A4-size regions produced as a result of bisection of that A3 paper by the centerline thereof.

Furthermore, with respect to the situation where printing is to be carried out on paper of size(s) larger than specified size(s) as described above, either of the print styles GIVE PRIORITY TO JOB or GIVE PRIORITY TO PAPER may be caused to be set in selective fashion at print server machine 2 (or this setting may likewise be carried out at layout editor 13). In the event that GIVE PRIORITY TO JOB is set at print server machine 2, because the system gives priority to finishing such job(s) as soon as possible, even if there is or are empty margin(s) remaining on paper of size(s) larger than specified size(s) sufficient to allow printing of other page(s) when printing of particular print job(s) on such larger-size paper is finished (e.g., even where the last page(s) of such job(s) is or are printed on only a region occupying one half of A3 paper, leaving a region in the other half unprinted and empty), such paper is immediately discharged and such print job(s) is or are immediately concluded. On the other hand, in the event that GIVE PRIORITY TO PAPER is set at print server machine 2, because the system gives priority to eliminating uneconomical use of such paper, if there is or are empty margin(s) remaining on paper of size(s) larger than specified size(s) sufficient to allow printing of other page(s) when printing of particular print job(s) on such larger-size paper is finished (e.g., where the last page(s) of such job(s) is or are printed on only an A4 region occupying one half of A3 paper, leaving an A4 region in the other half unprinted and empty), other print job(s) of specified size(s) such as is or are capable of being printed in such margin(s) is or are awaited, such paper being discharged only after page(s) of such other print job(s) is or are printed in margin(s) of such paper (e.g., after the first page(s) of subsequent print job(s) is or are printed on A4 region(s) in the remaining half or halves of A3 paper).

Furthermore, with respect to PRINT OPTIONS, whether to print name(s) of file(s) containing respective photo image(s), crop mark(s) for respective photo image(s), line(s) indicating external boundary or boundaries of respective photo image(s), studio name(s), client machine name(s), job ID(s), operator name(s), customer name(s), list(s) of name(s) of file(s) containing photo image(s) placed on page(s), print date(s), arbitrary comment(s), and/or other such supplemental information may be set (printing such supplemental information facilitates post-printing operations such as cutting and sorting of printed output by customer). In addition, with respect to any customer name(s) to be printed, list(s) of names of customers previously registered with the system may be displayed in popup fashion and customer name(s) selected therefrom.

Furthermore, with respect to AFTER PRINTING, whether to return job completion communication(s) to server status monitor 14 from print server(s) 34 shown in FIG. 3 after completion of execution of such print job(s) at printer(s), whether to leave data in connection with such print job(s) undeleted at print server machine 2 until deleted or altered by user(s), and other such optional operations to be carried out following completion of printing may be set. Absent a countermanding instruction for deletion from a user or presence of prescribed conditions causing deletion, print server machine 2 is such that print job data is as a rule left undeleted following completion of printing, being stored in disk storage at print server machine 2. Only in the event that the foregoing AFTER PRINTING setting has been set such that print job(s) is or are to be deleted following completion of printing does print server machine 2 delete such print job data, in which case it does so immediately after time or times when printing of such print job(s) is completed.

Moreover, with respect to the foregoing deletion of print job data, AVAILABLE SPACE and TIME PERIOD may be set as conditions for automatic deletion of stored print job data at print server machine 2. Where AVAILABLE SPACE has been set, if available disk storage space at print server machine 2 decreases to such set value(s) or less, print server machine 2 causes deletion of stored print job data, in order of oldness, recovering available disk storage space until it is the foregoing set value(s) or greater. Where TIME PERIOD has been set, print server machine 2 stores print job data for a time period corresponding to such set value(s) (e.g., 7 days), automatically deleting such print job data at time or times when stored time period(s) reach such set value(s).

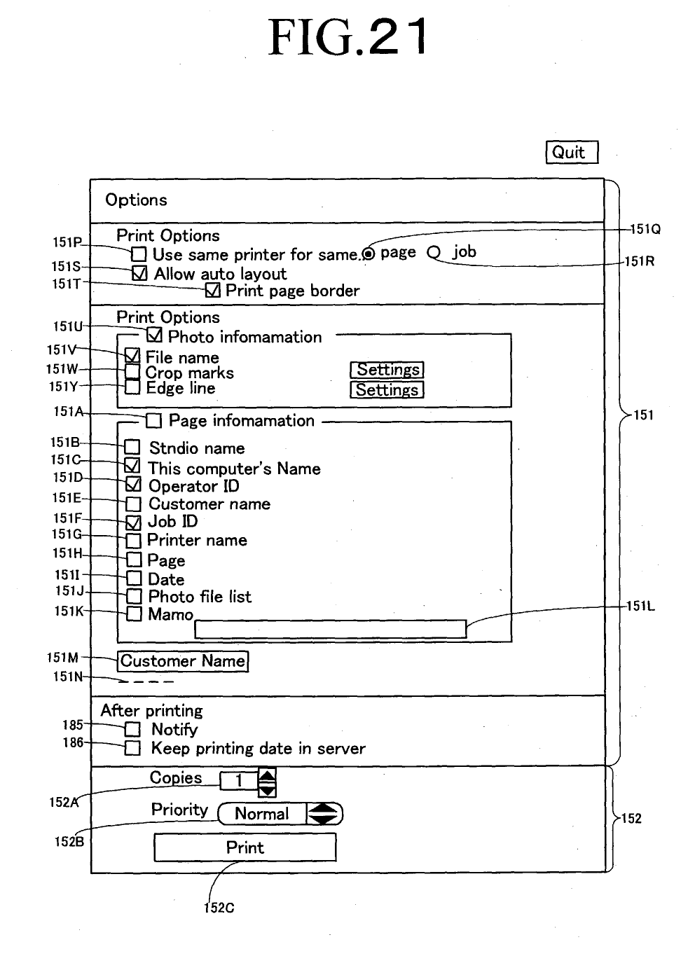

Option selection area 151 will now be described in more specific terms with reference to FIG. 21.

Settable at option selection area 151 in a manner such as is shown by way of example in FIG. 21 there may be OPTIONS items comprising PRINTER OPTIONS (CLUSTER PRINTING OPTIONS) items and/or PRINT OPTIONS items; a PAGE INFORMATION checkbox 151A; a STUDIO NAME checkbox 151B; a THIS COMPUTER'S NAME checkbox 151C; an OPERATOR ID checkbox 151D; a CUSTOMER NAME checkbox 151E; a JOB ID checkbox 151F; a PRINTER NAME checkbox 151G; a PAGE checkbox 151H; a DATE checkbox 151I; a PHOTO FILE LIST checkbox 151J; a MEMO checkbox 151K; memo text 151L; a CUSTOMER NAME button 151M; a CUSTOMER NAME indicator 151N; and/or AFTER PRINTING items. Settable at the PRINTER OPTIONS items there may be a USE SAME PRINTER FOR SAME checkbox 151P; a PAGE radio button 151Q; a JOB radio button 151R; an ALLOW AUTO LAYOUT checkbox 151S; and/or a PRINT PAGE BORDER checkbox 151T. Furthermore, settable at the PRINT OPTIONS items there may be a PHOTO INFORMATION checkbox 151U; a FILE NAME checkbox 151V; a CROP MARKS checkbox 151W; a CROP MARKS SETTING button 151X; an EDGE LINE checkbox 151Y; and/or an EDGE LINE SETTING button 151Z.

The OPTIONS items are for setting options in connection with print job(s), the PRINTER OPTIONS (CLUSTER PRINTING OPTIONS) items being those items among the foregoing OPTIONS items which are used for setting options in connection with distributed printing, and the PRINT OPTIONS items being those items among the foregoing OPTIONS items which are used for setting options in connection with photo information and page information.

At the PRINTER OPTIONS items, checking USE SAME PRINTER FOR SAME checkbox 151P causes JOB radio button 151R, for carrying out setting such that the same print job(s) is or are printed at the same printer(s), to be enabled. Note that because the PAGE radio button 151Q, for carrying out setting such that the same page(s) is or are printed at the same printer(s), is selected by default, it will be enabled regardless of whether USE SAME PRINTER FOR SAME checkbox 151P is checked.

Checking ALLOW AUTO LAYOUT checkbox 151S causes print job(s) to be subject to automatic layout. Checking same causes PRINT PAGE BORDER checkbox 151T to be enabled by default, as a result of which paper frame(s) will be printed.

At the PRINT OPTIONS items, PHOTO INFORMATION checkbox 151U, unchecked by default, causes respective photo information to be printed within respective photo frame(s) when checked. Checking PHOTO INFORMATION checkbox 151U causes FILE NAME checkbox 151V, CROP MARKS checkbox 151W, and EDGE LINE checkbox 151Y to be enabled.

FILE NAME checkbox 151V, checked by default, functions so as to cause file name(s) to be printed.

CROP MARKS checkbox 151W, unchecked by default, functions so as to cause crop marks for which settings have been entered to be printed. Such crop marks may also be displayed in preview fashion at layout template 149.

EDGE LINE checkbox 151Y, unchecked by default, functions so as to cause image frame(s) for which settings have been entered to be printed. Such image frame(s) may also be displayed in preview fashion at layout template 149.

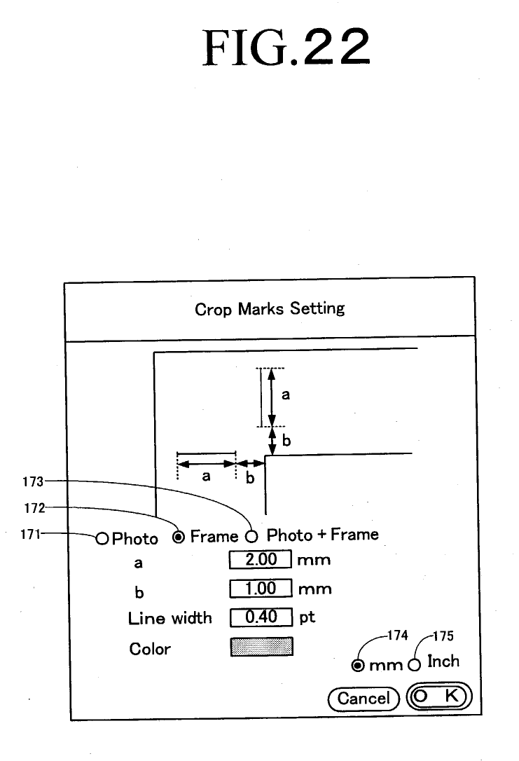

Clicking CROP MARKS SETTING button 151X causes a dialog box such as that shown in FIG. 22 to be displayed, making it possible to carry out settings in connection with printing of crop marks. The dialog box shown in FIG. 22 is provided with PHOTO radio button 171, FRAME radio button 172, and PHOTO+FRAME radio button 173. Clicking PHOTO radio button 171 causes crop marks to be printed for photo(s). Clicking FRAME radio button 172 causes crop marks to be printed for frame(s). Clicking PHOTO+FRAME radio button 173 causes crop marks to be printed for photo(s) and frame(s).

Note that as shown in FIG. 22 default settings are such that length a is 2 mm (100 mm maximum), length b is 1 mm (100 mm maximum), linewidth is 0.4 pt (28.3 pt, or approximately 10 mm, maximum) color is black, PHOTO radio button 171 is OFF, FRAME radio button 172 is ON, and PHOTO+FRAME radio button 173 is OFF. Furthermore, at the dialog box shown in FIG. 22, MM radio button 174, not INCH radio button 175, is selected.

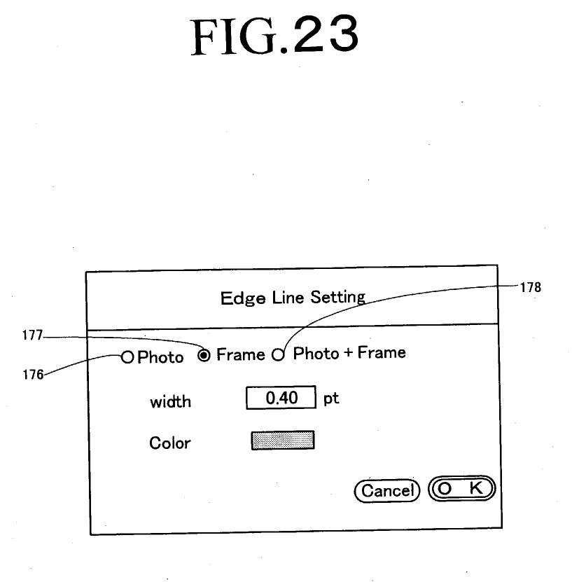

Clicking EDGE LINE SETTING button 151Z in FIG. 21 causes a dialog box such as that shown in FIG. 23 to be displayed, making it possible to carry out settings in connection with printing of photo frame(s). The dialog box shown in FIG. 23 is provided with PHOTO radio button 176, FRAME radio button 177, and PHOTO+FRAME radio button 178. Clicking PHOTO radio button 176 causes photo frame(s) to be printed around the outside of photo(s). Drawing of lines centered on photo edge(s) is prohibited. Clicking FRAME radio button 177 causes edge line(s) to be printed for frame(s). Clicking PHOTO+FRAME radio button 178 causes edge line(s) to be printed for photo(s) and frame(s).

Note that as shown in FIG. 23 default settings are such that linewidth is 0.4 pt (28.3 pt, or approximately 10 mm, maximum) color is black, PHOTO radio button 176 is OFF, FRAME radio button 177 is ON, and PHOTO+FRAME radio button 178 is OFF.

At FIG. 21, PAGE INFORMATION checkbox 151A, unchecked by default, causes respective page information to be printed within page information frame(s) when checked. Checking PAGE INFORMATION checkbox 151A causes STUDIO NAME checkbox 151B, THIS COMPUTER'S NAME checkbox 151C, OPERATOR ID checkbox 151D, CUSTOMER NAME checkbox 151E, JOB ID checkbox 151F, PRINTER NAME checkbox 151G, PAGE checkbox 151H, DATE (TIME) checkbox 151I, PHOTO FILE LIST checkbox 151J, and MEMO checkbox 151K to be enabled.

STUDIO NAME checkbox 151B, unchecked by default, causes name(s) of store(s) to be printed, e.g., after the fashion of STUDIO NAME: STUDIO 1, when checked.

THIS COMPUTER'S NAME checkbox 151C, checked by default, causes name(s) of client computer(s) to be printed, e.g., after the fashion of COMPUTER'S NAME: iMAC1.

OPERATOR ID checkbox 151D, checked by default, causes operator ID(s) to be printed, e.g., after the fashion of OPERATOR ID: T. HONDA.

CUSTOMER NAME checkbox 151E, unchecked by default, causes name(s) of customer(s) to be printed, e.g., after the fashion of CUSTOMER NAME: SHIMADA, when checked.

JOB ID checkbox 151F, checked by default, causes job ID(s) to be printed, e.g., after the fashion of JOB ID: 000160.

PRINTER NAME checkbox 151 G, unchecked by default, causes name(s) of printer(s) used for printing to be printed, e.g., after the fashion of PRINTER: #1 UPPER, when checked.

PAGE checkbox 151H, unchecked by default, causes page number(s) to be printed, e.g., after the fashion of PAGE: ⅓, when checked.

DATE checkbox 151I, unchecked by default, causes the time at the start of rendering to be printed, e.g., after the fashion of PRINT TIME: 2000-09-28-16-31-19, when checked.

PHOTO FILE LIST checkbox 151J, unchecked by default, causes printing of list(s) of names(s) of file(s) laid out on page(s)—e.g., after the fashion of FILE NAME: DSCF0071.JPG, DSCF0072.JPG, DSCF0073.JPG—when checked.

MEMO checkbox 151K, unchecked by default, causes printing of memo(s) which has or have been input, e.g., after the fashion of MEMO: “Test printing”, when checked. Note that the maximum number of characters which can be input is 250 (bytes).

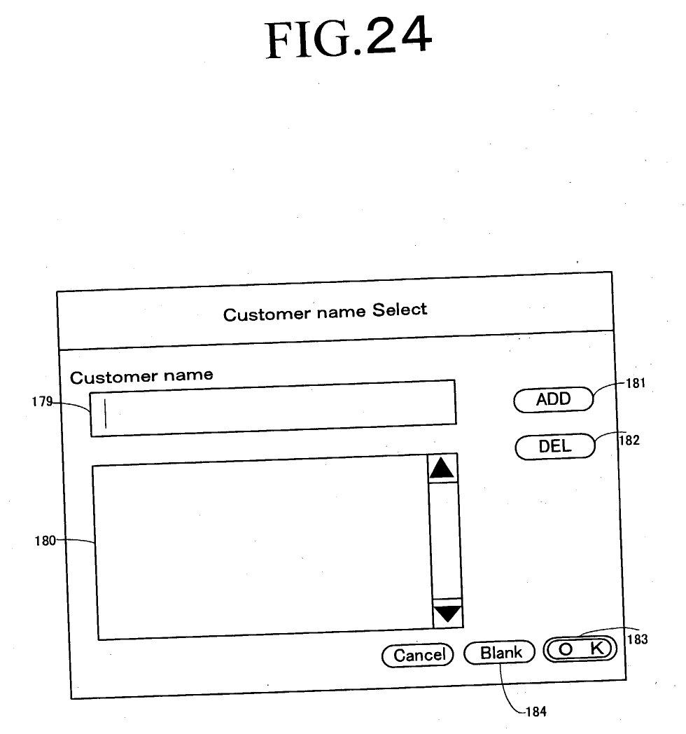

Current customer name(s) is or are displayed beside CUSTOMER NAME button 151M. Clicking CUSTOMER NAME button 151M cause display of a dialog box, such as is shown in FIG. 24, which is provided with CUSTOMER NAME edit box 179, CUSTOMER NAME list box 180, ADD button 181, DELETE button 182, OK button 183, BLANK button 184, and so forth, permitting selection and/or editing of customer name(s).

CUSTOMER NAME list box 180 is activated by entering character(s), matching item(s) as determined by a match in leading character(s) being displayed therein. Here, the maximum number of characters which can be input at CUSTOMER NAME list box 180 is set to 31 (bytes), and registered customer name(s) can be displayed. List(s) displayed at this CUSTOMER NAME list box 180 may be sorted in alphabetical order.

Clicking ADD button 181 causes the character string within edit box 179 to be added to the list at the foregoing list box 180 and causes it to assume a selected state. In the event that the character string within edit box 179 has previously been registered so that it already appears within the foregoing list box 180 when ADD button 181 is clicked, that character string will assume a selected state.

Clicking DELETE button 182 causes character string(s) within edit box 179 to be deleted from list box 180 and clears edit box 179.

Clicking OK button 183 causes the character string within edit box 179 to be set as customer ID and causes the dialog box shown in FIG. 24 to be closed. There is no direct connection between clicking of OK button 183 and addition of the foregoing character string to list box 180. Note that if there is no character string present within the foregoing edit box 179, there will be no change to the foregoing edit box 179 or the foregoing list box 180 despite the fact that OK button 183 is clicked.

Clicking BLANK button 184 causes a blank customer ID to be set and causes the dialog box shown in FIG. 24 to be closed.

AFTER PRINTING (OPTION) items at FIG. 21 are for setting options applicable following completion of printing, and comprise NOTIFY checkbox 185 and KEEP PRINTING DATA IN SERVER checkbox 186. NOTIFY checkbox 185 is unchecked by default but when checked causes message(s) to the effect that printing is finished from status display application(s) to be displayed when printing of prescribed print job(s) is finished.

KEEP PRINTING DATA IN SERVER checkbox 186 is unchecked by default but when checked causes the system to enter a PAUSE condition as corresponding print job(s) is or are registered so that it or they appear within job list(s) until corresponding print job(s) is or are deleted by user(s) or the settings thereof is or are altered.

At print command area 152 in FIG. 8, number(s) of copies to be printed and printing priority or priorities may be specified and execution of printing may be requested for print job(s) which is or are the subject of operations. When execution of printing is requested, layout editor 13 generates print job data for print job(s) currently being edited and sends same to file transfer server 31 of print server machine 2 shown in FIG. 3. As has already been described, print job data includes job script(s), layout script(s) for all print page(s) included in such job(s), everything placed within photo frame(s) at layout template(s) on such print page(s), and working ICC profile(s) caused to be set for such photo image(s). Note that photo image file(s) included within this print job data is or are not original photo image file(s) but is or are file(s) containing photo image(s) which has or have been subjected to adjustment with respect to dimension and/or direction during placement in photo frame(s) at layout template(s).

Print command area 152 will now be described in more specific terms with reference to FIG. 21.

Settable at print command area 152 in a manner such as is shown by way of example in FIG. 21 there may be COPIES edit box 152A, PRIORITY popup list 152B, and/or PRINT button 152C.

At COPIES edit box 152A, by clicking on either of the pair of buttons set above and below it is possible to specify the number of sheets to be printed for print job(s) which is or are the subject of operations.

At PRIORITY popup list 152B, by clicking up or down it is possible to specify printing priority or priorities for print job(s) which is or are the subject of operations. There are a total of five levels of priority which may be set, from NOW, representing the highest priority, to WAIT, representing the lowest priority, and including the three levels HIGH, NORMAL, and LOW therebetween.

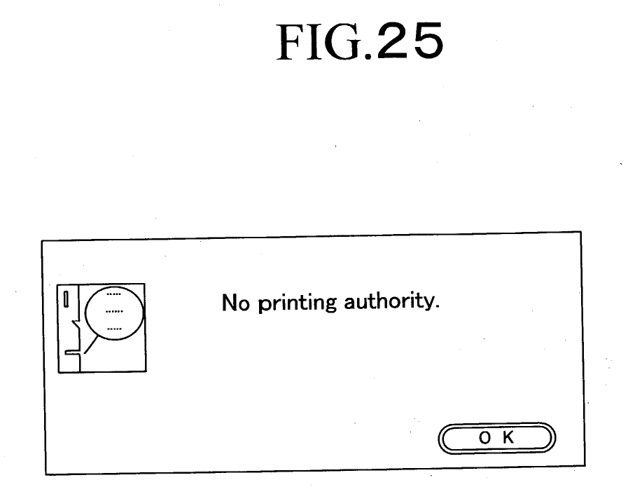

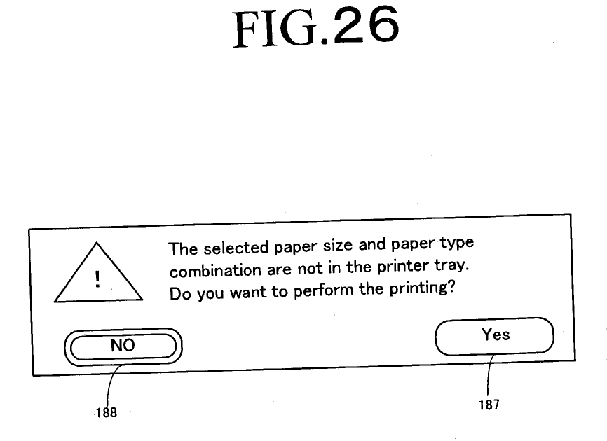

Clicking PRINT button 152C causes image file(s), layout information file(s), job file(s), color profile(s), and/or layout image thumbnail(s) required for printing to be transferred to print server machine 2. In the event that not even one image has been laid out, PRINT button 152C will be disabled and it will be impossible to carry out printing of print job(s) which is or are the subject of operations; moreover, in the event that there is or are page(s) for which not even one image has been laid out, such page(s) will not be printed. Furthermore, where there are identical image file(s), only one file will be transferred to print server machine 2. Furthermore, in the event that a user or the like does not have printing privileges, a message such as that shown by way of example in FIG. 25 is displayed and printing is not carried out. Furthermore, in the event that there is no printing paper in a cassette at printers 3A, 3B that matches the paper size and paper type selected at media/printer selection area 146, a message such as that shown by way of example in FIG. 26 is displayed. At FIG. 26, if YES button 187 is clicked then printing is carried out, but if NO button 188 is clicked then printing is not carried out.

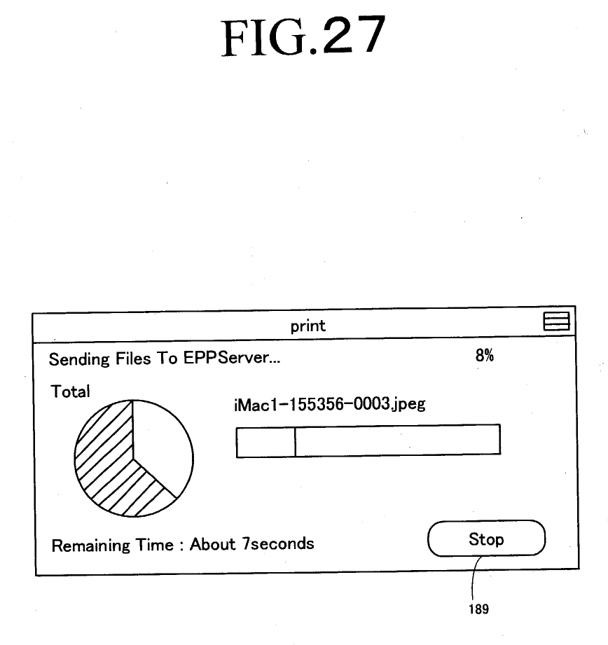

A dialog box displaying a progress bar such as that shown by way of example in FIG. 27 may be output during printing. STOP button 189 in FIG. 27 is clicked if it is desired that printing be cancelled. Following printing, at FIG. 21, COPIES edit box 152A is reset to “1” and PRIORITY popup list 152B is reset to “NORMAL”, and KEEP PRINTING DATA IN SERVER checkbox 186 is reinitialized to its unchecked state.

With the foregoing, print layout editing operations carried out on one print job are ended. Print layout editing operations may thereafter be continued, such operations being carried out on other print job(s).

Repeated reference is now made to FIG. 3 and FIG. 4.

At print server machine 2, print job data sent from layout editor 13 of client system 5 is accepted by file transfer server 31 and stored within job folder 33, and furthermore, print job data within job folder 33 is read by print server(s) 34. Based on such print job data, print server 34 creates print image data for all print page(s) making up such print job(s). At such time or times, by carrying out perceptual color matching on such photo image data using working ICC profile(s) for respective photo image(s) and printer ICC profile(s) corresponding to the output printer and output media combination, print server(s) 34 adjusts such photo image data included within print image data so as to produce color(s) when printed out that will most nearly approximate the color(s) present in working color space(s) of such photo image(s). In addition, print server 34 sends the created print image data for respective print page(s) to printer driver(s) 35A and/or 35B for output printer(s). This permits printing to take place at such printer(s).

With respect to output printer selection, print server(s) 34 carries or carry out control as follows based on setting(s) entered at media/printer selection area 146 of layout editor main window 140 shown in the aforementioned FIG. 8 and PRINTER OPTIONS setting(s) entered at option selection area 151 (these settings being written to job script(s)). To wit, if specific printer(s) has or have been specified at media/printer selection area 146, print server(s) 34 uses or use only such specified printer(s) as output printer(s). On the other hand, if AUTOSELECT has been entered for the printer specification at media/printer selection area 146, print server(s) 34 is or are free to select output printer(s) in correspondence to conditions existing at printer(s) at any given time. Furthermore, even where distributed printing is to be carried out, if setting has been made at the aforementioned PRINTER OPTIONS in option selection area 151 to the effect that the same page(s) and/or the same job(s) is or are to be printed at the same printer(s), then print server(s) 34 selects or select the same printer(s) as output printer(s) for all sets of copies of the same page(s) and/or the same job(s).

As has already been described, print server(s) 34 ascertains or ascertain execution status of respective print job(s) and/or status of printer(s) 3A, 3B, recording same at print information database 36. Information pertaining to user(s) at such studio(s) is also recorded at print information database 36.

Status monitor 14 of client system 5 requests information pertaining to errors generated by printer(s) 3A, 3B and/or completion of execution of respective print job(s) from print server machine 2 at time intervals (e.g., every 10 minutes, etc.) previously set by user(s). Responsive to this request, print server(s) 34 at print server machine 2 reads or read from print information database 36 new history information, not yet sent to client system 5, pertaining to completion of execution of print job(s) and/or printer error(s), sending same to status monitor 14 of client system 5 by way of file transfer server 31, and status monitor 14 displays that information on monitor(s) at client system 5.

Print job execution history or histories, status of printer(s) 3A, 3B, and/or user information at print information database 36 may be accessed at any time(s) by means of WWW browser 17 at client system 5. Moreover, administrator(s) at such studio(s) may use WWW browser 17 to register new user(s) at print information database 36.

Furthermore, by putting log uploader 38 of print server machine 2 into WATCHDOG MODE, regardless of whether user(s) is or are present thereat, upon occurrence of error(s) at printer(s) 3A, 3B or other such abnormality or abnormalities, electronic mail to such effect may be sent substantially in real time from center server machine 8 to email address(es) 93 of user(s). Various information managed at center database 84 of center server machine 8 may also be accessed at any time(s) by means of WWW browser 17 at client system 5.

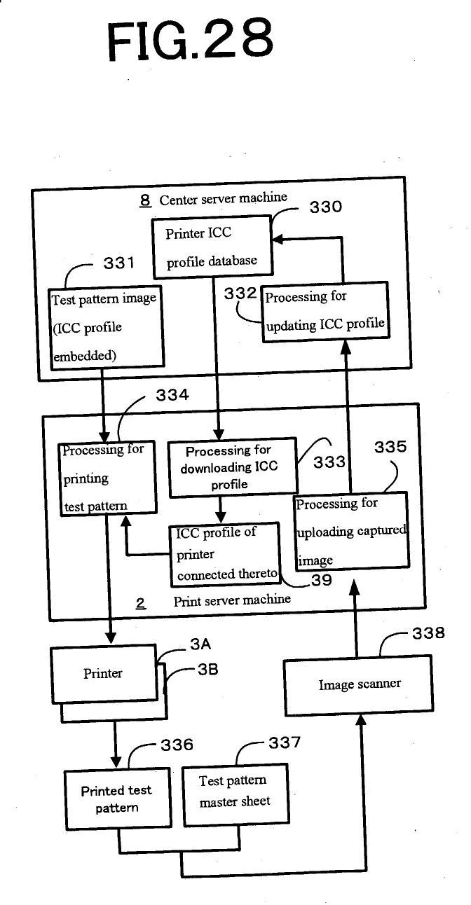

FIG. 28 shows functional constitution of print server machine 2 and center server machine 8 for updating printer ICC profile(s).

As shown in FIG. 28, center server machine 8 possesses printer ICC profile database 330, which stores printer ICC profile(s) for all printers respectively installed at all photo studio(s). Stored therein for each respective printer are a plurality of printer ICC profiles respectively corresponding to a plurality of usable types of print media. Printer ICC profile(s) for respective printer(s) are associated with machine number(s) of respective printer(s). At time or times when studio system(s) 1 of respective studio(s) is or are installed, print server machine 2 carries out ICC profile download processing 333. ICC profile download processing 333 is such that machine number(s) of printer(s) 3A, 3B of such studio(s) is or are communicated to center server machine 8, printer ICC profile(s) for such printer(s) 3A, 3B is or are downloaded from center server machine 8, and such downloaded printer ICC profile(s) is or are stored in prescribed folder(s) 39. Thereafter, when creating print image(s), printer ICC profile(s) stored within such folder(s) 39 may be used for color matching.

In order to investigate changes in printer(s) 3A, 3B with time, user(s) may whenever appropriate or at regular internals execute test pattern printing processing 334, which is installed at print server machine 2. Test pattern printing processing 334 is such that image data for prescribed test pattern(s) is downloaded from center server machine 8. Embedded in downloaded test pattern image data is or are ICC profile(s) indicating color space(s) of such test pattern image data. Test pattern printing processing 334 is such that printer ICC profile(s) corresponding to combination(s) of print media and printer(s) 3A and/or 3B being investigated is or are read from folder(s) 39, perceptual color matching is carried out using such printer ICC profile(s) and test pattern image data ICC profile(s), adjusting such test pattern image data, and such adjusted test pattern image data is used to carry out printing of test pattern(s) at printer(s) 3A and/or 3B being investigated.

Test pattern printout(s) 336 obtained as a result thereof may be sent from studio(s) to the center by mail, for example. At the center, colorimetry may be carried out on such test pattern printout(s) 336, and based on results of such colorimetry new printer ICC profile(s) may be created which indicates or indicate the present color space(s) of printer(s) 3A and/or 3B being investigated, such new printer ICC profile(s) being input to center server machine 8. At center server machine 8, printer ICC profile(s) for printer(s) 3A and/or 3B being investigated which is or are present at printer ICC profile database 330 may be updated to such new printer ICC profile(s). Print server machine 2 thereafter downloads, from center server machine 8, new printer ICC profile(s) for printer(s) 3A and/or 3B being investigated, and updates printer ICC profile(s) for printer(s) 3A and/or 3B being investigated which is or are present within folder(s) 39 to such downloaded new printer ICC profile(s). Print server machine 2 can then use such new printer ICC profile(s).

Moreover, electronic method(s) such as the following may be used as method(s) for sending test pattern printout(s) 336 to the center.

To wit, as shown in FIG. 28, a user at a photo studio mounts test pattern printout(s) 336 and preprepared test pattern master sheet(s) 337 on the platen of image scanner 388, and causes image scanner 388 to scan in such test pattern printout(s) 336 and master sheet(s) 337 in a single image scanning run. What is here referred to as a test pattern master sheet 337 is a sheet on which a test pattern is printed with accurate color(s), same being distributed in advance to respective photo studio(s). Image data captured from printout(s) 336 and master sheet(s) 337 which is output from image scanner 388 may be acquired by print server machine 2, and may be uploaded to center server machine 8 by means of captured image data uploading processing 335. At center server machine 8, ICC profile updating processing 332 is such that any difference in color(s) between test pattern printout(s) 336 and master sheet(s) 337 is detected based on such uploaded captured image data; furthermore, based on results of such detection, new printer ICC profile(s) is or are created which indicates or indicate the present color space(s) of printer(s) 3A and/or 3B being investigated, and corresponding printer ICC profile(s) within printer ICC profile database 330 is or are updated.

Whereas embodiments of the present invention have been described above, these have been presented as examples for purposes of describing the present invention and without intent to limit the scope of the present invention to these embodiments alone. The present invention may accordingly be carried out in the context of a wide variety of other embodiments without departing from the essence thereof.

Whereas in the foregoing embodiments functionality for editing photographs and creating print job and functionality for sending print jobs to printers and managing print information were split between separate computer machines, these being a client machine and a print server machine, such constitution wherein functionalities are split between or among separate machines has been presented only by way of example and it is possible to carry out the present invention in the context of other machine constitutions. For example, all of the foregoing functionalities may be carried out by a single computer machine. Printer(s) may also split a portion of the foregoing functionalities. Or the foregoing functionalities may be split even more finely among even more computer machines.

1. A print layout editing program which is a computer program for editing one or more print layouts representing how one or more images to be printed is or are to be arranged on print media, the print layout editing program being capable of causing one or more computers to carry out
one or more steps wherein one or more desired sets of image data are displayed and the layout on print media of at least one of the set or sets of image data is edited; and
one or more steps wherein one or more sets of print job data are created, at least one of the set or sets of print job data being in accordance with at least one of the edited layout or layouts and including at least one of the desired set or sets of image data and one or more color profiles previously embedded in that image data.

2. A print layout editing program according to the program recited at claim 1, which, in the event that at least one of the desired set or sets of image data has no color profile embedded therein, is further capable of causing at least one of the computer or computers to carry out one or more steps wherein one or more prescribed color profiles are automatically treated as if it or they had previously been embedded therein.

3. A layout editing program which is a computer program for editing one or more print layouts representing how one or more images to be printed is or are to be arranged on print media, the layout editing program being capable of causing one or more computers to carry out
one or more steps wherein one or more desired templates are displayed after being selected from one or more template libraries, each of which contains a plurality of templates, each template comprising one or more image frames of prescribed size or sizes arranged at prescribed location or locations on one or more pages;
one or more steps wherein a plurality of images are displayed; and
one or more steps wherein one or more user-desired sets of image data corresponding to one or more images among the displayed plurality of images is or are pasted in or on one or more user-specified image frames present within at least one of the displayed template or templates so as to permit one or more print layouts to be edited.

4. A layout editing program according to the program recited at claim 3 which is further capable of causing at least one of the computer or computers to carry out one or more steps wherein one or more users are able to edit one or more pages such that at least one image size can be freely set without use of the template or templates.

5. A layout editing program according to the program recited at claim 3 which is further capable of causing at least one of the computer or computers to carry out one or more steps wherein
one or more packages are selected in response to user request or requests, each package representing a set comprising a plurality of templates of the same page size;
one or more steps wherein a plurality of templates contained within at least one of the selected package or packages are displayed in list or table fashion; and
one or more steps wherein one or more user-desired templates among the plurality of templates displayed in list or table fashion are selected and used for print layout editing of one or more pages.

6. A layout editing program according to the program recited at claim 5 which is further capable of causing at least one of the computer or computers to carry out one or more steps wherein arrangement of one or more image frames present within at least one of the template or templates can be changed in response to user request or requests.

7. A layout editing program according to the program recited at claim 3 which is further capable of causing at least one of the computer or computers to carry out one or more steps wherein, responsive to user request or requests, one or more new templates is created using one or more template creation tools, and at least one of the created template or templates is added to at least one of the template library or libraries.

8. A layout editing program according to the program recited at claim 7 which is further capable of causing at least one of the computer or computers to carry out
one or more steps wherein connection or connections is or are made to one or more other computers by way of communication network or networks, and one or more of the desired template or templates are obtained from one or more template libraries at at least one of the other computer or computers; and
one or more steps wherein at least one of the obtained template or templates is used to carry out print layout editing.

9. A layout editing program according to the program recited at claim 3 which is further capable of causing at least one of the computer or computers to carry out
one or more steps wherein, when at least one of the image or images is to be placed in at least one of the image frame or frames, either a first or a second placement style is selected in response to user request or requests;
in the event that the first placement style is selected, the at least one image is made the maximum size which will allow all of it to fit completely within the at least one image frame, margin or margins being added as necessary during placement thereof in the at least one image frame; and
in the event that the second placement style is selected, the at least one image is made the minimum size which will allow it to fit within the at least one image frame without production of a margin or margins, portion or portions of the at least one image which extends or extend beyond the at least one image frame being trimmed as necessary during placement thereof in the at least one image frame.

10. A layout editing program according to the program recited at claim 3 which is further capable of causing at least one of the computer or computers to carry out one or more steps wherein, when one or more images which is or are long horizontally is or are to be placed in one or more image frames which is or are long vertically, and/or when one or more images which is or are long vertically is or are to be placed in one or more image frames which is or are long horizontally, at least one of the respective image or images is rotated by 90 degrees before being placed in the corresponding image frame.

11. A layout editing program according to the program recited at claim 10 which is further capable of causing at least one of the computer or computers to carry out one or more steps wherein, responsive to user request or requests, either clockwise or counterclockwise may be selected as the direction in which the at least one image is to be rotated at at least one of the rotating step or steps.

12. A layout editing program according to the program recited at claim 3 which is further capable of causing at least one of the computer or computers to carry out one or more steps wherein, when editing one or more print layouts for respective pages in one or more print jobs comprising a plurality of pages, a different template is applied to each page in response to user request or requests.

13. A layout editing program which is a computer program for editing one or more print layouts representing how one or more images to be printed is or are to be arranged on print media, the layout editing program being capable of causing one or more computers to carry out
one or more steps wherein one or more print jobs are created based on results of editing; and,
responsive to user request or requests when creating at least one of the print job or jobs,
(1) one or more steps wherein instruction as to which among the plurality of printers is or are acceptable as printer or printers to be used for printing at least one of the print job or jobs is included within at least one of the print job or jobs;
(2) one or more steps wherein instruction to use one specific printer among the plurality of printers as the printer to be used for printing at least one of the print job or jobs is included within at least one of the print job or jobs; and
one or more steps wherein at least one of the step or steps at either (1) or (2), above, is selected.

14. A layout editing program according to the program recited at claim 13 which is further capable of causing at least one of the computer or computers to carry out one or more steps wherein, in the event that at least one of the step or steps at (1) is selected, instruction to print all of the print job or jobs using the same printer or printers is included within at least one of the print job or jobs in response to user request or requests.

15. A layout editing program according to the program recited at claim 13 which is further capable of causing at least one of the computer or computers to carry out one or more steps wherein, in the event that at least one of the step or steps at (1) is selected, instruction to print identical pages within at least one of the print job or jobs using the same printer or printers is included within at least one of the print job or jobs in response to user request or requests.

16. A layout editing program which is a computer program for editing one or more print layouts representing how one or more images to be printed is or are to be arranged on print media, the layout editing program being capable of causing one or more computers to carry out one or more steps wherein whether to print at least one of
(1) one or more page borders,
(2) one or more image frame borders,
(3) one or more crop marks,
(4) one or more customer names,
(5) one or more image file names,
(6) one or more computer machine names, and
(7) one or more editing staffperson names, on one or more pages subject to editing is specified in response to user request or requests.

17. A layout editing program which is a computer program for editing one or more print layouts representing how one or more images to be printed is or are to be arranged on print media, the layout editing program being capable of causing one or more computers to carry out
one or more steps wherein one or more print layouts are edited for each page constituting one or more print jobs;
one or more steps wherein print job data is formed based on results of this editing; and
one or more steps wherein one or more messages to the effect that printing is finished are automatically displayed when printing of one or more print jobs currently subject to editing is finished.

18. A layout editing program according to the program recited at claim 17 which is further capable of causing at least one of the computer or computers to carry out one or more steps wherein, responsive to user request or requests, selection is made as to whether at least a portion of the print job data should be automatically saved or automatically deleted when printing thereof is finished as described above.
